(19) United States
(12) Patent Application Publication
(10) Pub. No.: US 2022/0270476 A1
(43) Pub. Date: Aug. 25, 2022

(54) COLLABORATIVE AUTOMATED DRIVING SYSTEM

(71) Applicant: CAVH LLC, Fitchburg, WI (US)

(72) Inventors: Bin Ran, Fitchburg, WI (US); Tianyi Chen, Madison, WI (US); Xiaotian Li, Madison, WI (US); Yang Cheng, Middleton, WI (US); Shen Li, Madison, WI (US); Shuoxuan Dong, Madison, WI (US); Yifan Yao, Madison, WI (US); Kunsong Shi, Madison, WI (US); Haotian Shi, Madison, WI (US); Keshu Wu, Madison, WI (US); Sicheng Fu, Madison, WI (US)

(21) Appl. No.: 17/667,683

(22) Filed: Feb. 9, 2022

Related U.S. Application Data
(60) Provisional application No. 63/149,804, filed on Feb. 16, 2021.

(51) Int. Cl. G08G 1/01; G08G 1/0967; B60W 60/00; G05D 1/02; H04W 4/44

(52) U.S. Cl. CPC G08G 1/0116; G08G 1/096725; G08G 1/096783; B60W 60/00253; G05D 1/0287; H04W 4/44; B60W 2556/40; B60W 2556/50; G05D 2201/0213

(57) ABSTRACT

Provided herein is technology relating to automated driving and particularly, but not exclusively, to a system configured to provide full vehicle operations and control for connected and automated vehicles (CAV) and, more particularly, to a system configured to manage and/or control CAV by sending individual vehicles with detailed and time-sensitive control instructions for lateral and longitudinal movement of vehicles, including vehicle following, lane changing, route guidance, and related information.

### STATEMENT OF RELATED APPLICATIONS

This application claims priority to U.S. Provisional Patent Application No. 63/149,804, filed Feb. 16, 2021, the entire contents of which are incorporated herein by reference for all purposes.

### FIELD

Provided herein is technology relating to automated driving and particularly, but not exclusively, to a system configured to provide full vehicle operations and control for connected and automated vehicles (CAV) and, more particularly, to a system configured to manage and/or control CAV by sending individual vehicles with detailed and time-sensitive control instructions for lateral and longitudinal movement of vehicles, including vehicle following, lane changing, route guidance, and related information.

### BACKGROUND

Connected and Automated Vehicles (CAV) that are capable of automated driving under certain conditions are in development. However, deployment of CAV has been limited by high costs (e.g., capital and/or energy costs) associated with the numerous sensors and computational devices provided on CAV, and CAV performance is limited by the functional capabilities of sensors provided on CAV.

### SUMMARY

Very recently, technologies have been developed to address some of these problems. For example, an Automated Driving System (ADS) and/or components thereof is/are described in, e.g., U.S. Pat. App. Pub. Nos. 20190096238; 20190340921; 20190244521; 20200005633; 20200168081; and 20200021961; in U.S. Pat. App. Ser. Nos. 16/996,684; 63/004,551; and 63/004,564, and in U.S. Pat. Nos. 10,380,886; and 10,692,365, each of which is incorporated herein by reference. In some embodiments, ADS technologies provide systems, components of systems, methods, and related functionalities that overcome the limitations of current CAV technologies. In particular, some embodiments of ADS technologies comprise roadside infrastructure configured to provide roadside sensing, roadside prediction, roadside planning and/or decision making, and/or roadside control of CAV. These ADS technologies (e.g., systems, components of systems, methods, and related functionalities) provide automated driving, e.g., by providing support for CAV to perform automated driving tasks on a road.

As described herein, embodiments of the technology improve and/or extend previous ADS technologies, e.g., the CAVH technology and related technologies described in, e.g., U.S. Pat. App. Pub. Nos. 20190096238; 20190340921; 20190244521; 20200005633; 20200168081; and 20200021961; in U.S. Pat. App. Ser. Nos. 16/996,684; 63/004,551; and 63/004,564, and in U.S. Pat. Nos. 10,380,886; and 10,692,365, each of which is incorporated herein by reference. In particular, the technology described herein provides improved CAVH technologies (e.g., CAVH systems, components of CAVH systems, CAVH methods, and related CAVH functionalities) by enhancing the CAVH subsystem design scheme and adding further subsystems and algorithms to the CAVH technology. In some embodiments, the technology described herein relates to a collaborative automated driving system (CADS) comprising 1) a cooperative management subsystem; 2) a road subsystem; 3) a vehicle subsystem; 4) a communication subsystem; 5) a user subsystem; and/or 6) a supporting subsystem. Importantly, embodiments of the CADS technology described herein provide a comprehensive solution for implementing CAVH technologies more efficiently in a broad variety of different operational design domains using a system-level binding method.

Accordingly, provided herein is a collaborative automated driving system (CADS). In some embodiments, the CADS comprises a cooperative management (CM) subsystem; a road subsystem; a vehicle subsystem; a user subsystem; a communications subsystem; and/or a supporting subsystem. In some embodiments, the CADS optionally comprises a cloud subsystem and/or a map subsystem. In some embodiments, the CADS is configured to provide transportation management. In some embodiments, the CADS is configured to provide full vehicle operations and control for connected and automated vehicle and highway systems by sending individual vehicles with detailed and time-sensitive control instructions for vehicle operations.

In some embodiments, the CM subsystem is configured to process information, coordinate and allocate resources, and/or send traffic operations instructions to the road subsystem; the vehicle subsystem; the user subsystem; the communications subsystem; and/or a supporting subsystem. In some embodiments, the CM subsystem is configured to perform a binding method.

In some embodiments, the road subsystem comprises RIU. In some embodiments, the RIU are configured to receive data and/or information from connected vehicles, detect traffic conditions, and/or send targeted control instructions to vehicles.

In some embodiments, the vehicle subsystem is configured to provide automated driving to a vehicle. In some embodiments, the vehicle subsystem is configured to provide automated driving to a plurality of vehicles and the plurality of vehicles comprises vehicles having different intelligence levels, vehicles having different brands and/or manufacturers, vehicles having different model years, and/or different vehicle models. In some embodiments, the vehicle subsystem is configured to coordinate with the CM subsystem; the road subsystem; the user subsystem; the communications subsystem; and/or a supporting subsystem to provide automated driving for vehicles.

In some embodiments, the user subsystem comprises vehicle users. In some embodiments, the user subsystem comprises transportation administrators. In some embodiments, vehicle users are drivers and/or passengers. In some embodiments, the user subsystem exchanges information with the cooperative management subsystem; the road subsystem; the vehicle subsystem; the communication subsystem; and/or the supporting subsystem.

In some embodiments, the communication subsystem is configured to provide wired and/or wireless communication services to the CADS and/or CADS subsystems.

In some embodiments, the supporting subsystem is configured to provide physical and/or technical support to the CADS. In some embodiments, the supporting subsystem is configured to provide physical and/or technical support for the transportation services provided to users. In some embodiments, the supporting subsystem is configured to provide physical and/or technical support to transportation operations and collaborative automated driving. In some embodiments, the supporting subsystem comprises a cloud subsystem; an edge computing subsystem; a map subsystem; a high-precision positioning system; and/or a cybersecurity system.

In some embodiments, the CADS is configured to complement, enhance, backup, elevate, and/or replace automated driving functions of a vehicle. In some embodiments, the CADS comprises a module configured to complement, enhance, backup, elevate, and/or replace automated driving functions of a vehicle. In some embodiments, the automated driving functions of a vehicle comprise sensing, decision making, and/or control. In some embodiments, the automated driving functions of a vehicle comprise sensing, prediction, planning, and/or control. In some embodiments, the CADS is configured to complement, enhance, backup, elevate, and/or replace automated driving functions of a vehicle driving in a long-tail environment and/or scenario.

In some embodiments, the CM subsystem comprises a TCC and/or a TCU. In some embodiments, the CM subsystem comprises a regional TCC; a corridor TCC; a segment TCU; and/or a point TCU. In some embodiments, the CM subsystem is configured to be operated independently by a service provider.

In some embodiments, the CM subsystem is configured to perform a binding method comprising identifying the vehicle subsystem, the road subsystem, or the cloud subsystem as a dominant subsystem. In some embodiments, identifying the vehicle subsystem, road subsystem, or cloud subsystem as a dominant subsystem comprises checking the Operation Design Domain (ODD) of a site or corridor requesting CADS services. In some embodiments, the CM is configured to perform a Vehicle-Dominant CM (VDCM) method, a Road-Dominant CM (RDCM) method, and/or a Cloud-Dominant CM (CDCM) method. In some embodiments, the CM is configured to perform a Cloud-Dominant CM (VDCM) method when the cloud subsystem is identified as the dominant subsystem. In some embodiments, the cloud subsystem is configured to control the CM subsystem and the CM subsystem is configured to control and/or manage the road subsystem; the vehicle subsystem; the communication subsystem; the user subsystem; and/or the supporting subsystems. In some embodiments, the CM is configured to perform a Vehicle-Dominant CM (VDCM) method when the vehicle subsystem is identified as the dominant subsystem. In some embodiments, the vehicle subsystem is configured to control the CM subsystem and the CM subsystem is configured to control and/or manage the road subsystem; the communication subsystem; the user subsystem; and/or the supporting subsystems. In some embodiments, the vehicle subsystem is configured to complement, enhance, backup, elevate, and/or replace vehicle centric automated driving functions. In some embodiments, the CM is configured to perform a Road-Dominant CM method when the road subsystem is identified as the dominant subsystem. In some embodiments, the road subsystem is configured to control the CM subsystem and the CM subsystem is configured to control and/or manage the vehicle subsystem; the communication subsystem; the user subsystem; and/or the supporting subsystems.

In some embodiments, the cloud subsystem comprises and/or provides a macroscopic cloud, a mesoscopic cloud, and/or microscopic cloud.

In some embodiments, the vehicle subsystem is configured to receive information from the cooperative management subsystem; the road subsystem; the communication subsystem; the user subsystem; and/or the supporting subsystems. In some embodiments, the vehicle subsystem comprises a vehicle adapter and/or a vehicle intelligent unit (VIU). In some embodiments, the VIU is configured to manage automated driving functions. In some embodiments, the vehicle adapter provides an interface configured to exchange information between a vehicle and CADS, between a vehicle and a CADS subsystem, between a vehicle and road infrastructure, between a vehicle and a user, and/or between a vehicle and a supporting subsystem. In some embodiments, the VIU is configured to manage sensing, prediction, planning, and/or control functions for a vehicle. In some embodiments, the VIU is configured to manage sensing, prediction, planning, and/or control functions for a plurality of vehicles and the plurality of vehicles comprises vehicles having different intelligence levels, vehicles having different brands and/or manufacturers, vehicles having different model years, and/or different vehicle models.

In some embodiments, the road subsystem is configured to receive information from the cooperative management subsystem; the vehicle subsystem; the communication subsystem; the user subsystem; and/or the supporting subsystems. In some embodiments, the road subsystem is configured to complete and/or support automated driving functions. In some embodiments, the road subsystem is configured to manage sensing, prediction, planning, and/or control functions for a vehicle. In some embodiments, the road subsystem is configured to manage sensing, prediction, planning, and/or control functions for a plurality of vehicles and the plurality of vehicles comprises vehicles having different intelligence levels, vehicles having different brands and/or manufacturers, vehicles having different model years, and/or different vehicle models.

In some embodiments, the user subsystem comprises a vehicle user and/or an administrator. In some embodiments, the user subsystem is configured for use by a vehicle user and/or an administrator. In some embodiments, a vehicle user is a driver and/or a passenger. In some embodiments, the user subsystem receives information from the cooperative management subsystem; the road subsystem; the vehicle subsystem; the communication subsystem; and/or the supporting subsystem and provides the information to a vehicle user and/or to an administrator. In some embodiments, the information provided to a vehicle user is provided for a notification, a service, and/or emergency control of a vehicle. In some embodiments, the information provided to an administrator is provided to control a vehicle and/or to manage traffic. In some embodiments, the information provided to an administrator is provided to control and/or to manage the CADS.

In some embodiments, the map subsystem is configured to provide map information to the vehicle subsystem and/or to the road subsystem. In some embodiments, the map subsystem comprises high-precision maps. In some embodiments, the high-precision maps are provided at different resolutions. In some embodiments, the map subsystem provides methods for high-precision positioning or location identification. In some embodiments, the map subsystem is configured to integrate information from the cooperative management subsystem; the road subsystem; the vehicle subsystem; the communication subsystem; the user subsystem; and/or other supporting subsystems. In some embodiments, the map subsystem is configured to support automated driving functions. In some embodiments, the map subsystem is configured to provide navigation functions, positioning or location identification functions, and/or dynamic sensing and route planning functions.

In some embodiments, the communication subsystem is configured to support information exchange among the cooperative management subsystem; the road subsystem; the vehicle subsystem; the communication subsystem; the user subsystem; and/or the supporting subsystems.

In some embodiments, the CADS is configured to support automated driving functions of a vehicle driving in a long-tail environment and/or scenario. In some embodiments, the long-tail environment and/or scenario comprises an incident (e.g., traffic accident, vehicle crash); an event (e.g., a sports event, a concert, or other gathering); a construction and/or work zone; extreme and/or adverse weather; a hazardous road (e.g., comprising an animal, debris, broken pavement, steep grade, sharp curve, slippery surface); an unclear road marking, sign, and/or geometric design; and/or a high concentration of pedestrians and/or bicycles.

Also provided herein are methods employing any of the systems described herein for the management of one or more aspects of automated driving of a CAV and/or for the management of one or more aspects of traffic control. For example, in some embodiments, the technology provides a method comprising providing a CADS to provide vehicle control and/or traffic management. The methods include those processes undertaken by individual participants in the system (e.g., drivers, public or private local, regional, or national transportation facilitators, government agencies, etc.) as well as collective activities of one or more participants working in coordination or independently from each other.

Some portions of this description describe the embodiments of the technology in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all steps, operations, or processes described.

In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet; CAVH, IRIS, or CAH communications; and/or a cellular network). See, e.g., U.S. Pat. App. Pub. No. 20200005633, incorporated herein by reference.

Embodiments of the technology may also relate to an apparatus for performing the operations herein. This apparatus may be specially constructed for the required purposes and/or it may comprise a general-purpose computing device selectively activated or reconfigured by a computer program stored in the computer. Such a computer program may be stored in a non-transitory, tangible computer readable storage medium or any type of media suitable for storing electronic instructions, which may be coupled to a computer system bus. Furthermore, any computing systems referred to in the specification may include a single processor or may be architectures employing multiple processor designs for increased computing capability.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings.

FIG. 1 is a schematic drawing showing an overview of an exemplary embodiment of a collaborative automated driving system. 102: Road subsystem; 103: Vehicle subsystem; 104: Communication subsystem; 105: User subsystem; 106: Supporting subsystem; 107: Macroscopic traffic control center; 108: Regional traffic control center; 109: Corridor traffic control center; 110: Segment traffic control unit; 111: Point traffic control unit; 112: Road Intelligent Unit (RIU); 113: Vehicle Intelligent Unit (VIU); 114: Vehicle user (e.g., driver and/or passenger); 115: Administrator (e.g., an administrator having permission to retrieve and/or send information and/or instructions from and/or to other subsystems); 116: Cloud system; 117: Edge computing system; 118: Map system; 119: High-precision position system; 120: Cyber security system.

FIG. 2 is a flow chart describing an exemplary embodiment of a binding method.

FIG. 3 is a schematic drawing showing an exemplary structure of an embodiment of a cloud subsystem. 301: Macroscopic Cloud; 302: Mesoscopic Cloud; 303: Microscopic Cloud.

FIG. 4 is a flow chart describing an exemplary embodiment of a Cloud-Dominant Cooperative Management (CDCM) method.

FIG. 5 is a schematic drawing showing an exemplary structure of an embodiment of a vehicle subsystem. 501: RIU Adapter (e.g., Adapter to the Road Subsystem, e.g., comprising road infrastructure); 502: Cloud Adapter (e.g., Adapter to the Cloud Subsystem); 503: Map Port (e.g., Adapter to the Map Subsystem); 504: Vehicle Adapter (e.g., Adapter to the VIU); 505: CAN Bus Adapter (e.g., Adapter to the CAN Bus); 506: User UI (e.g., Vehicle user interface); 507: Communication Unit (e.g., communication assembly of the VIU); 508: Processing Unit (e.g., processing and computation assembly of the VIU); 509: Sensing Unit (e.g., Sensing assembly of the VIU).

FIG. 6 is a flow chart showing an exemplary embodiment of a Vehicle-Dominant Cooperative Management (VDCM) method.

FIG. 7 is a schematic drawing showing an exemplary structure of an embodiment of a road subsystem. 701: Cloud Adapter; 702: System Adapter; 703: Sensing Unit; 704: Processing Unit; 705: Communication Unit; 706: VIU Adapter; 707: User UI; 708: Map Port.

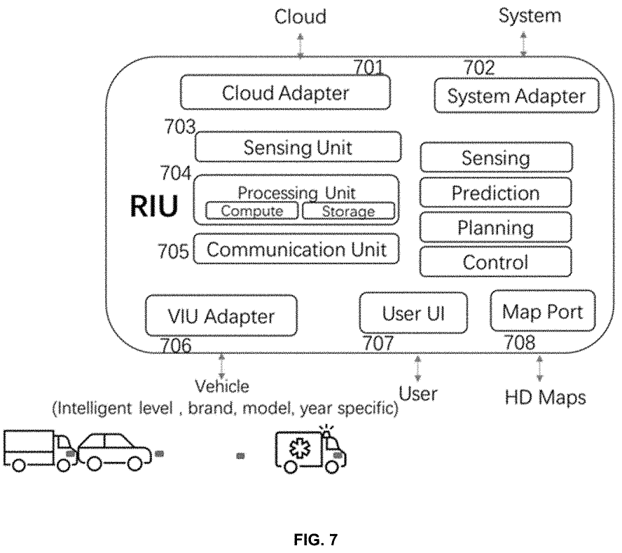

FIG. 8 is a flow chart showing an exemplary embodiment of a Road-Dominant Cooperative Management (RDCM) method.

FIG. 9 is a schematic drawing showing an exemplary structure of an embodiment of a user subsystem and data (e.g., information) flows of the user subsystem. 901: Information received by the vehicle user from the vehicle subsystem. 902: Information received by the vehicle user from the road subsystem; 903: Information received by the vehicle user from the cloud subsystem; 904: Information received by the vehicle user from the map subsystem; 905: Control instructions from the vehicle user to the vehicle subsystem; 906: Information received by the administrator from the vehicle subsystem; 907: Information received by the administrator from the road subsystem; 908: Information received by the administrator from the cloud subsystem; 909: Information received by the administrator from the map subsystem; 910: Information sent by the administrator to the cooperative management subsystem for control and management.

FIG. 10 is a flow chart showing an exemplary embodiment of a method of the user subsystem.

FIG. 11 is a schematic drawing showing an exemplary embodiment of a map subsystem and data (e.g., information) flows among the map subsystem and other subsystems. 1101: Information flow between the navigation module and the vehicle subsystem; 1102: Information flow between the positioning module and the vehicle subsystem; 1103: Information flow between the dynamic sensing and planning module and the vehicle subsystem; 1104: Information flow between the navigation module and the road subsystem; 1105: Information flow between the positioning module and the road subsystem; 1106: Information flow between the dynamic sensing and planning module and the road subsystem; 1107: Information flow between the navigation module and the user subsystem; 1108: Information flow between the positioning module and the user subsystem; 1109: Information flow between the dynamic sensing and planning module and the user subsystem; 1110: Information flow between the navigation module and the cloud subsystem; 1111: Information flow between the positioning module and the cloud subsystem; 1112: Information flow between the dynamic sensing and planning module and the cloud subsystem.

FIG. 12 is a schematic drawing showing an exemplary embodiment of a communication subsystem and data (e.g., information) flows of the communication subsystem. 1201: User or People subsystem information flow to everything (P2X); 1202: Vehicle subsystem information flow to everything (V2X); 1203: Map subsystem information flow to everything (M2X); 1204: Road or Infrastructure subsystem information flow to everything (I2X); 1205: Cloud subsystem information flow to everything (C2X); 1206: communication technology standards to support P2X communication; 1207: communication technology standards to support V2X communication; 1208: communication technology standards to support M2X communication; 1209: communication technology standards to support I2X communication; 1210: communication technology standards to support C2X communication.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is technology relating to automated driving and particularly, but not exclusively, to a system configured to provide full vehicle operations and control for connected and automated vehicles (CAV) and, more particularly, to a system configured to manage and/or control CAV by sending individual vehicles with detailed and time-sensitive control instructions for lateral and longitudinal movement of vehicles, including vehicle following, lane changing, route guidance, and related information.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the word “presence” or “absence” (or, alternatively, “present” or “absent”) is used in a relative sense to describe the amount or level of a particular entity (e.g., component, action, element). For example, when an entity is said to be “present”, it means the level or amount of this entity is above a pre-determined threshold; conversely, when an entity is said to be “absent”, it means the level or amount of this entity is below a pre-determined threshold. The pre-determined threshold may be the threshold for detectability associated with the particular test used to detect the entity or any other threshold. When an entity is “detected” it is “present”; when an entity is “not detected” it is “absent”.

As used herein, an “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, the term “number” shall mean one or an integer greater than one (e.g., a plurality).

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods. For example, a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language may be a compiled or interpreted language, and combined with hardware implementations.

As used herein, the term “automated driving system” (abbreviated “ADS”) refers to a system that performs driving tasks (e.g. lateral and longitudinal control of the vehicle) for a vehicle and thus allows a vehicle to drive with reduced human control of driving tasks and/or without human control of driving tasks.

As used herein, the term Operational Design Domain (abbreviated ODD) refers to the operating conditions under which a given automated driving system and/or feature thereof is specifically designed to function, including, but not limited to, characteristics and/or restrictions related to environmental, geographical, and/or time-of-day factors, and/or related to the presence or absence of certain traffic or roadway characteristics. In some embodiments, the ODD is defined by SAE International Standard J3016, “Taxonomy and Definitions for Terms Related to Driving Automation Systems for On-Road Motor Vehicles” (J3016_201806), which is incorporated herein by reference.

As used herein, the term “Connected Automated Vehicle Highway System” (“CAVH System”) refers to a comprehensive system (e.g., an ADS) providing full vehicle operations and control for connected and automated vehicles (CAV), and, more particularly, to a system controlling CAVs by sending individual vehicles with detailed and time-sensitive control instructions for vehicle following, lane changing, route guidance, and related information. A CAVH system comprises sensing, communication, and control components connected through segments and nodes that manage an entire transportation system. CAVH systems comprise four control levels: vehicle; roadside unit (RSU), which, in some embodiments, is similar to or the same as a roadside intelligent unit (RIU); traffic control unit (TCU); and traffic control center (TCC). See U.S. Pat. Nos. 10,380,886; 10,867,512; and/or 10,692,365, each of which is incorporated herein by reference.

As used herein, the term “Intelligent Road Infrastructure System” (“IRIS”) refers to a system that facilitates vehicle operations and control for CAVH systems. See U.S. Pat. Nos. 10,867,512 and/or 10,692,365, each of which is incorporated herein by reference. In some embodiments, an IRIS provides transportation management and operations and individual vehicle control for connected and automated vehicles (CAV). For example, in some embodiments, an IRIS provides a system for controlling CAVs by sending individual vehicles with customized, detailed, and time-sensitive control instructions and traffic information for automated vehicle driving, such as vehicle following, lane changing, route guidance, and other related information.

As used herein, the term “GPS” refers to a global navigation satellite system (GNSS) that provides geolocation and time information to a receiver. Examples of a GNSS include, but are not limited to, the Global Positioning System developed by the United States, Differential Global Positioning System (DGPS), BeiDou Navigation Satellite System (BDS) System, GLONASS Global Navigation Satellite System), European Union Galileo positioning system, the NavIC system of India, and the Quasi-Zenith Satellite System (QZSS) of Japan.

As used herein, the term “vehicle” refers to any type of powered transportation device, which includes, and is not limited to, an automobile, truck, bus, motorcycle, or boat. The vehicle may normally be controlled by an operator or may be unmanned and remotely or autonomously operated in another fashion, such as using controls other than the steering wheel, gear shift, brake pedal, and accelerator pedal.

As used herein, the term “automated vehicle” (abbreviated as “AV”) refers to an automated vehicle in an automated mode, e.g., at any level of automation (e.g., as defined by SAE International Standard J3016, “Taxonomy and Definitions for Terms Related to Driving Automation Systems for On-Road Motor Vehicles” (published in 2014 (J3016_201401) and as revised in 2016 (J3016_201609) and 2018 (J3016_201806), each of which is incorporated herein by reference)).

As used herein, the term “allocate”, “allocating”, and similar terms referring to resource distribution also include distributing, arranging, providing, managing, assigning, controlling, and/or coordinating resources.

As used herein, the term “resource” refers to computational capacity (e.g., computational power, computational cycles, etc.); memory and/or data storage capacity; sensing capacity; communications capacity (e.g., bandwidth, signal strength, signal fidelity, etc.); and/or electrical power.

As used herein, the term “service” refers to a process, a function that performs a process, and/or to a component or module that is configured to provide a function that performs a process.

As used herein, the term “adapter” refers to an interface connecting two components, systems, subsystems, modules, etc. In some embodiments, an adapter provides communications between the two components, systems, subsystems, modules (e.g., for exchange of data, instructions, and/or information between the two components, systems, subsystems, modules). In some embodiments, an adapter provides a translation service for conversion of a first data format output by a first component, system, subsystem, or module into a second data format output for use by a second component, system, subsystem, or module. In some embodiments, an “adapter” defines the types of requests that can be made; the types of responses to requests that can be made; how requests and responses to requests are made; the data formats that are used for requests, responses to requests, and data exchange; and/or other conventions defining the interaction of two components, systems, subsystems, modules, etc.

As used herein, the term “connected vehicle” or “CV” refers to a connected vehicle, e.g., configured for any level of communication (e.g., V2V, V2I, and/or I2V).

As used herein, the term “connected and autonomous vehicle” or “CAV” refers to an autonomous vehicle that is able to communicate with other vehicles (e.g., by V2V communication), with roadside intelligent units (RIU), traffic control signals, and/or other infrastructure (e.g., an ADS or component thereof) or devices. That is, the term “connected autonomous vehicle” or “CAV” refers to a connected autonomous vehicle having any level of automation (e.g., as defined by SAE International Standard J3016 (2014)) and communication (e.g., V2V, V2I, and/or I2V).

As used herein, the term “data fusion” refers to integrating a plurality of data sources to provide information (e.g., fused data) that is more consistent, accurate, and useful than any individual data source of the plurality of data sources.

As used herein, the term “configured” refers to a component, module, system, subsystem, etc. (e.g., hardware and/or software) that is constructed and/or programmed to carry out the indicated function.

As used herein, the terms “determine,” “calculate,” “compute,” and variations thereof, are used interchangeably to any type of methodology, processes, mathematical operation, or technique.

As used herein, the term “reliability” refers to a measure (e.g., a statistical measure) of the performance of a system without failure and/or error. In some embodiments, reliability is a measure of the length of time and/or number of functional cycles a system performs without a failure and/or error.

As used herein, the term “support” when used in reference to one or more components of an ADS, CAVH, CAV, and/or a vehicle providing support to and/or supporting one or more other components of the ADS, CAVH, CAV, and/or a vehicle refers to, e.g., exchange of information and/or data between components and/or levels of the ADS, CAVH, CAV, and/or a vehicles; sending and/or receiving instructions between components and/or levels of the ADS, CAVH, CAV, and/or a vehicles; and/or other interaction between components and/or levels of the ADS, CAVH, CAV, and/or a vehicles that provide functions such as information exchange, data transfer, messaging, and/or alerting.

As used herein, the term “ADS component” or “component of an ADS” refers individually and/or collectively to one or more of components of an ADS and/or a CAVH system, e.g., a VIU, RIU, TCC, TCU, TCC/TCU, TOC, CAV, a supporting subsystem, and/or a cloud component.

As used herein, the term “roadside intelligent unit” (abbreviated “RIU”) may refer to one RIU, a plurality of RIU, and/or a network of RIU.

As used herein, the term “critical point” refers to a portion or region of a road that is identified as appropriate to be provided embodiments of the function allocation technology provided herein. In some embodiments, a critical point is categorized as a “static critical point” and in some embodiments, a critical point is categorized as a “dynamic critical point”. As used herein, a “static critical point” is a point (e.g., region or location) of a road that is a critical point based on identification of road and/or traffic conditions that are generally constant or that change very slowly (e.g., on a time scale longer than a day, a week, or a month) or only by planned reconstruction of infrastructure. As used herein, a “dynamic critical point” is a point (e.g., region or location) of a road that is a critical point based on identification of road conditions that change (e.g., predictably or not predictably) with time (e.g., on a time scale of an hour, a day, a week, or a month). Critical points based on historical crash data, traffic signs, traffic signals, traffic capacity, and road geometry are exemplary static critical points. Critical points based on traffic oscillations, real-time traffic management, or real-time traffic incidents are exemplary dynamic critical points.

In some embodiments, critical points are identified using, e.g., historical crash data (e.g., the top 20% (e.g., top 15-25% (e.g., top 15, 16, 17, 18, 19, 20, 21, 22, 23, 24, or 25%)) most frequent crash points in a road system are identified as critical points); traffic signs (e.g., where certain traffic signs (e.g., accident-prone areas) are detected are identified as critical points); traffic capacity (e.g., the top 20% (e.g., top 15-25% (e.g., top 15, 16, 17, 18, 19, 20, 21, 22, 23, 24, or 25%)) highest traffic capacity areas are identified as critical points); road geometry (e.g., roads with critical road geometry (e.g., curves, blind spots, hills, intersections (e.g., signalized intersections, stop sign intersections, yield sign intersections), roundabouts) are identified as critical points); traffic oscillation (e.g., points with significant traffic oscillations are identified as critical points); real-time traffic management (e.g., points with potential traffic management are identified as critical points); and/or real-time traffic incident (e.g., points with traffic incidents (e.g., accident, crash, congestion, construction or maintenance, weather-related event, etc.) or vehicle malfunction are identified as critical points).

As used herein, the terms “microscopic”, “mesoscopic”, and “macroscopic” refer to relative scales in time and space. In some embodiments, the scales include, but are not limited to, a microscopic level relating to individual vehicles (e.g., longitudinal movements (car following, acceleration and deceleration, stopping and standing) and lateral movements (lane keeping, lane changing)), a mesoscopic level relating to road corridors and/or segments (e.g., special event early notification, incident prediction, merging and diverging, platoon splitting and integrating, variable speed limit prediction and reaction, segment travel time prediction, and/or segment traffic flow prediction), and a macroscopic level relating to an entire road network (e.g., prediction of potential congestion, prediction of potential incidents, prediction of network traffic demand, prediction of network status, prediction of network travel time). In some embodiments, a time scale at a microscopic level is from 1 to 10 milliseconds and is relevant to tasks such as vehicle control instruction computation. In some embodiments, a time scale at a mesoscopic level is typically from 10 to 1000 milliseconds and is relevant to tasks such as incident detection and pavement condition notification. In some embodiments, a time scale at a macroscopic level is longer than 1 second and is relevant to tasks such as route computing.

As used herein, the automation and/or intelligence levels of vehicles (V), infrastructure (I), and system (S) are described with respect to an “intelligence level” and/or an “automation level”. In some embodiments, the vehicle intelligence and/or automation level is one of the following: V0: No automation functions; V1: Basic functions to assist a human driver to control a vehicle; V2: Functions to assist a human driver to control a vehicle for simple tasks and to provide basic sensing functions; V3: Functions to sense the environment in detail and in real-time and to complete relatively complicated driving tasks; V4: Functions to allow vehicles to drive independently under limited conditions and sometimes with human driver backup; and V5: Functions to allow vehicles to drive independently without human driver backup under all conditions. As used herein, a vehicle having an intelligence level of 1.5 (V1.5) refers to a vehicle having capabilities between vehicle intelligence 1 and vehicle intelligence level 2, e.g., a vehicle at V1.5 has minimal or no automated driving capability but comprises capabilities and/or functions (e.g., hardware and/or software) that provide control of the V1.5 vehicle by a CAVH system (e.g., the vehicle has “enhanced driver assistance” or “driver assistance plus” capability).

In some embodiments, the infrastructure intelligence and/or automation level is one of the following: I0: No functions; I1: Information collection and traffic management wherein the infrastructure provides primitive sensing functions in terms of aggregated traffic data collection and basic planning and decision making to support simple traffic management at low spatial and temporal resolution; I2: I2X and vehicle guidance for driving assistance, wherein, in addition to functions provided in I1, the infrastructure realizes limited sensing functions for pavement condition detection and vehicle kinematics detection, such as lateral and/or longitudinal position, speed, and/or acceleration, for a portion of traffic, in seconds or minutes; the infrastructure also provides traffic information and vehicle control suggestions and instructions for the vehicle through I2X communication; I3: Dedicated lane automation, wherein the infrastructure provides individual vehicles with information describing the dynamics of surrounding vehicles and other objects on a millisecond time scale and supports full automated driving on CAVH-compatible vehicle dedicated lanes; the infrastructure has limited transportation behavior prediction capability; I4: Scenario-specific automaton wherein the infrastructure provides detailed driving instructions for vehicles to realize full automated driving in certain scenarios and/or areas, such as locations comprising predefined geo-fenced areas, where the traffic is mixed (e.g., comprises automated and non-automated vehicles); essential vehicle-based automation capability, such as emergency braking, is provided as a backup system in case the infrastructure fails; and I5: Full infrastructure automation wherein the infrastructure provides full control and management of individual vehicles under all scenarios and optimizes a whole road network where the infrastructure is deployed; vehicle automation functionality is not necessary provided as a backup; full active safety functions are available.

In some embodiments, the system intelligence and/or automation level is one of the following: S0: no function; S1: the system provides simple functions for individual vehicles such as cruise control and passive safety function; the system detects the vehicle speed, location, and distance; S2: the system comprises individual intelligence and detects vehicle functioning status, vehicle acceleration, and/or traffic signs and signals; individual vehicles make decisions based on their own information and have partially automated driving to provide complicated functions such as assisting vehicle adaptive cruise control, lane keeping, lane changing, and automatic parking; S3: the system integrates information from a group of vehicles and behaves with ad-hoc intelligence and prediction capability, the system has intelligence for decision making for the group of vehicles and can complete complicated conditional automated driving tasks such as cooperative cruise control, vehicle platooning, vehicle navigation through intersections, merging, and diverging; S4: the system integrates driving behavior optimally within a partial network; the system detects and communicates detailed information within the partial network and makes decisions based on both vehicle and transportation information within the network and handles complicated, high level automated driving tasks, such as navigating traffic signal corridors, and provides optimal trajectories for vehicles within a small transportation network; S5: vehicle automation and system traffic automation, wherein the system optimally manages an entire transportation network; the system detects and communicates detailed information within the transportation network and makes decisions based on all available information within the network; the system handles full automated driving tasks, including individual vehicle tasks and transportation tasks, and coordinates all vehicles to manage traffic.

In some embodiments, the system dimension is dependent on the vehicle and infrastructure dimensions, e.g., as represented by the following equation (S=system automation; V=vehicle intelligence; and I=infrastructure intelligence):

S=f(V, I)

In some embodiments, vehicle intelligence is provided by and/or related to the CAV Subsystem and the infrastructure intelligence is provided by and/or related to the CAH Subsystem. One of ordinary skill in the art may refer to SAE International Standard J3016, “Taxonomy and Definitions for Terms Related to Driving Automation Systems for On-Road Motor Vehicles” (published in 2014 (J3016_201401) and as revised in 2016 (J3016_201609) and 2018 (J3016_201806)), which provides additional understanding of terms used in the art and herein.

### Description

As described herein, embodiments of the technology provide a comprehensive system for automated driving. In particular, the technology provides a collaborative automated driving system (CADS) configured to provide, support, and/or facilitate full vehicle (e.g., CAV) operations and control for connected and automated vehicle and highway (CAVH) systems, e.g., by sending individual vehicles with detailed and time-sensitive control instructions. As described herein, one advantage of the improved ADS (e.g., CAVH) technologies provided by the CADS is a high flexibility and configurability that allows implementation of the CADS in a broad variety of operational environments and situations.

As described herein, in some embodiments, the CADS technology comprises a number of several subsystems. In some embodiments, the CADS comprises a dominant CADS subsystem provided for a particular environment and/or driving scenario for which the dominant CADS subsystem is appropriate and thus provides an efficient implementation of the CADS. Accordingly, the technology provides a number of CADS variants each characterized by a dominant CADS subsystem and providing an appropriate and efficient implementation of the CADS for a particular use, scenario, environment, and/or driving scenario.

The technology described herein comprises previous CAVH technologies and/or improves previous CAVH technologies, e.g., as described in U.S. Pat. No. 10,380,886, which provides a system-oriented and fully-controlled CAVH system for various levels of connected and automated vehicles and highways; and as described in U.S. Pat. No. 10,867,512 and U.S. patent application Ser. No. 17/076,585, each of which provides an Intelligent Road Infrastructure System (IRIS) and related methods for providing vehicle operations and control for connected automated vehicle highway (CAVH) systems.

In some embodiments, CADS comprises one or more of the following physical subsystems: (1) a cooperative management subsystem; (2) a road subsystem; (3) a vehicle subsystem; (4) a user subsystem; (5) a communication subsystem; and/or (6) a supporting subsystem.

In some embodiment, the CADS comprises a cooperative management (CM) subsystem configured to provide the brain (e.g., central core functionality and/or intelligence) of the CADS. In some embodiments, the cooperative management subsystem comprises a hierarchy of traffic control centers (TCC) and/or traffic control units (TCU). In some embodiments, the cooperative management subsystem comprises one or more of each of: (1) a macroscopic TCC; (2) a regional TCC; (3) a corridor TCC; (4) a segment TCU; and/or (5) a point TCU; and combinations thereof. In some embodiments, the CM is configured to provide driving intelligence allocation, function allocation, resource allocation, device allocation, and/or system integration.

In some embodiments, the supporting subsystem comprises one or more of: (1) a cloud system; (2) an edge computing system; (3) a map system; (4) a high-precision positioning system; and/or (5) a cybersecurity system.

In some embodiments, the road subsystem is configured to provide data sensing, data processing, control signal delivery, and/or information distribution. In some embodiments, the road subsystem is combined and/or integrated with a TCU. In some embodiments, the road subsystem is configured to provide full or partial sensing functions, planning functions, decision making functions, and/or control functions.

In some embodiments, the CADS is configured to complement, enhance, elevate, backup, and/or replace automated driving functions of a vehicle (e.g., as discussed below). For example, in some embodiments, the CADS is configured to complement, enhance, elevate, backup, and/or replace vehicle sensing and perception functions, decision making functions, and/or control functions. In some embodiments, the CADS is configured to provide automated driving functions of a vehicle to complete driving tasks in long-tail scenarios, e.g., sensor data, driving events, and/or driving scenarios that occur with a low frequency or a small number of times (e.g., sensor data, driving events, and/or driving scenarios that have a very low probability of occurrence). Thus, in some embodiments, the CADS provides sensing and perception functions, decision making functions, and control functions as appropriate for long-tail scenarios e.g., sensor data, driving events, and/or driving scenarios that occur with a low frequency or a small number of times (e.g., sensor data, driving events, and/or driving scenarios that have a very low probability of occurrence). Exemplary long-tail scenarios include, but are not limited to, vehicle accidents; special events (e.g., sports events, hazard evacuation, etc.); construction and/or work zones; extreme and/or adverse weather (e.g., snowstorm, icy road, heavy rain, etc.); hazardous roads (e g animals on roads, rough roads, gravel, bumpy edges, uneven expansion joints, slick surfaces, standing water, debris, uphill grade, downhill grade, sharp turns, no guardrails, narrow road, narrow bridge, etc.); unclear road markings, unclear signing, and/or unclear geometric designs; high density of pedestrians and/or bicycles. Thus, in some embodiments, the CADS supports the normal operation of automated driving for long-tail scenarios by managing traffic in areas affected by a vehicle accident; managing traffic in areas affected by sports events, concerts, and/or hazard evacuation; providing support for automated driving in construction and/or work zones; providing support for automated driving in extreme and/or adverse weather; providing detailed lane and/or signage information for unclear sections and/or areas; and/or providing support for automated driving in areas comprising high densities of pedestrians and/or bicycles. In some embodiments, the CADS provides support to automated driving for the scenarios comprising extreme and/or adverse weather by providing and/or using supplemental sensing from the road subsystem. In some embodiments, the CADS provides support to automated driving for the scenarios comprising extreme and/or adverse weather by providing ad-hoc sensing strategies. In some embodiments, the CADS provides support to automated driving for the scenarios comprising extreme and/or adverse weather by using prediction and/or planning algorithms for a specific weather condition. In some embodiments, the CADS provides support to automated driving for the scenarios comprising construction and/or work zones by using information obtained from government databases (e.g., road closure configuration, lane closure information, construction location, and/or construction start/end time). In some embodiments, the CADS provides support to automated driving for the scenarios comprising construction and/or work zones by using detailed information from roadside sensing (e.g., real-time high-definition (HD) maps) and/or supplemental object detection.

In some embodiments, the CADS “complements” the automated driving functions of a vehicle by providing sensing and perception, decision-making, and/or vehicle control functions for a vehicle that is not able to perform one or more of sensing and perception, decision-making, and/or vehicle control functions. Accordingly, in some embodiments, the CADS “completes” the suite of automated driving functions by providing the automated driving functions that are not provided by the vehicle or that are not adequately provided by the vehicle.

In some embodiments, the CADS “enhances” the automated driving functions of a vehicle by improving the vehicle driving functions provided by the vehicle. For example, in some embodiments, the CADS enhances automated driving functions of a vehicle by improving sensing and perception, decision-making, and/or vehicle control functions for a vehicle that is not adequately performing sensing and perception, decision-making, and/or vehicle control functions.

In some embodiments, the CADS “backs-up” the automated driving functions of a vehicle by providing system redundancies configured to provide sensing and perception, decision-making, and/or vehicle control functions to a vehicle when a vehicle experiences a failure that decreases the sensing and perception, decision-making, and/or vehicle control functions of the vehicle.

In some embodiments, the CADS “elevates” a vehicle intelligence level from a lower vehicle intelligence level to a higher vehicle intelligence level. In some embodiments, the CADS elevates a vehicle automation level from a lower vehicle automation level to a higher vehicle automation level, where the vehicle automation level is as described herein and/or as defined by SAE International Standard J3016, “Taxonomy and Definitions for Terms Related to Driving Automation Systems for On-Road Motor Vehicles” (published in 2014 (J3016_201401) and as revised in 2016 (J3016_201609) and 2018 (J3016_201806), each of which is incorporated herein by reference.

In some embodiments, the CADS “replaces” the automated driving functions of a vehicle by fully and/or partially replacing the vehicle driving functions provided by the vehicle with vehicle driving functions provided by the CADS. For example, in some embodiments, the CADS fully and/or partially replaces one or more automated driving functions of a vehicle by fully and/or partially replacing sensing and perception, decision-making, and/or vehicle control functions for a vehicle that is not performing sensing and perception, decision-making, and/or vehicle control functions and/or for a vehicle that is not adequately and/or not fully performing sensing and perception, decision-making, and/or vehicle control functions. In some embodiments, the CADS “replaces” the automated driving functions of a vehicle by fully and/or partially replacing the vehicle driving functions provided by the vehicle with vehicle driving functions provided by the CADS during an emergency situation and/or in a long-tail scenario.

In some embodiments, the technology provides binding methods (e.g., system-level binding methods). In some embodiments, binding methods comprise a Vehicle-Dominant CM (VDCM) method, a Road-Dominant CM (RDCM) method, and/or a Cloud-Dominant CM (CDCM) method that complete the functions of a CADS. In some embodiments, binding methods determine and/or identify a service provider that provides services to the CM subsystem. In some embodiments, a service provider that provides services to the CM subsystem is an original equipment manufacturer (OEM). In some embodiments, a service provider that provides services to the CM subsystem is an automaker. In some embodiments, a service provider that provides services to the CM subsystem is a government agency. In some embodiments, a service provider that provides services to the CM subsystem is a contractor. In some embodiments, a service provider that provides services to the CM subsystem is an internet company. In some embodiments, a service provider that provides services to the CM subsystem is a technology company. In some embodiments, a service provider that provides services to the CM subsystem is a telecommunications company. In some embodiments, a service provider that provides services to the CM subsystem is a service provider that develops, rents, and/or purchases a CM subsystem.

In some embodiments, the CDCM method comprises receiving information from RIU and/or VIU; and using the information received from RIU and/or VIU to allocate driving intelligence to the RIU and/or VIU to complete driving tasks (e.g., sensing, prediction, planning, and/or control). In some embodiments, methods comprise using the information received from RIU and/or VIU to identify RIU and/or VIU that have insufficient driving intelligence to complete driving tasks (e.g., sensing, prediction, planning, and/or control). In some embodiments, methods comprise using the information received from RIU and/or VIU to identify RIU and/or VIU that require an allocation of driving intelligence to the RIU and/or VIU to complete driving tasks (e.g., sensing, prediction, planning, and/or control). In some embodiments, methods comprise using the information received from RIU and/or VIU to identify RIU and/or VIU that require an allocation of driving intelligence to the RIU and/or VIU to complete driving tasks (e.g., to provide adequate driving intelligence to RIU and/or VIU to complete driving tasks (e.g., sensing, prediction, planning, and/or control)). Accordingly, in some embodiments, the CDCM method comprises receiving information from RIU and/or VIU; and allocating driving intelligence to the RIU and/or VIU, e.g., to complete driving tasks (e.g., to provide adequate driving intelligence to RIU and/or VIU to complete driving tasks (e.g., sensing, prediction, planning, and/or control)). In some embodiments, methods comprise providing a microscopic cloud and allocating driving intelligence to an RIU and/or VIU using the microscopic cloud. In some embodiments, the CDCM method comprises computing using the cloud subsystem. In some embodiments, the CDCM method comprises sending instructions to a CADS subsystem (e.g., road subsystem; vehicle subsystem; user subsystem; communication subsystem; and/or supporting subsystem) using the cloud subsystem.

In some embodiments, the RDCM method comprises receiving information from a subsystem (e.g., road subsystem; vehicle subsystem; user subsystem; communication subsystem; and/or supporting subsystem); and using the information received from the subsystem to allocate resources to a vehicle to complete driving tasks (e.g., sensing, prediction, planning, and/or control). In some embodiments, RDCM methods comprise using the information received from the subsystem to identify a vehicle that has insufficient resources to complete driving tasks (e.g., sensing, prediction, planning, and/or control). In some embodiments, RDCM methods comprise using the information received from the subsystem to identify a vehicle that requires an allocation of resources to the vehicle to complete driving tasks (e.g., sensing, prediction, planning, and/or control). In some embodiments, RDCM methods comprise using the information received from the subsystem to identify a vehicle that requires an allocation of resources to the vehicle to complete driving tasks (e.g., to provide adequate resources to the vehicle to complete driving tasks (e.g., sensing, prediction, planning, and/or control)). Accordingly, in some embodiments, the RDCM method comprises receiving information from a subsystem (e.g., road subsystem; vehicle subsystem; user subsystem; communication subsystem; and/or supporting subsystem); and allocating resources to a vehicle, e.g., to complete driving tasks (e.g., to provide adequate resources to the vehicle to complete driving tasks (e.g., sensing, prediction, planning, and/or control)). In some embodiments, the RDCM method comprises requesting resources for a vehicle to complete driving tasks (e.g., sensing, prediction, planning, and/or control). In some embodiments, the RDCM method comprises proactively requesting resources for a vehicle to complete driving tasks (e.g., sensing, prediction, planning, and/or control). In some embodiments, the RDCM method comprises identifying future resources needed for a vehicle to complete driving tasks (e.g., sensing, prediction, planning, and/or control). In some embodiments, the RDCM method comprises predicting future resources needed for a vehicle to complete driving tasks (e.g., sensing, prediction, planning, and/or control). In some embodiments, the RDCM method comprises modeling future resources needed for a vehicle to complete driving tasks (e.g., sensing, prediction, planning, and/or control). In some embodiments, RDCM methods comprise identifying vehicle control instructions for a vehicle to execute.

In some embodiments, the VDCM method comprises receiving requirements and/or requests from the vehicle subsystem and obtaining resources needed from the roadside infrastructure and other subsystems (e.g., the road subsystem; vehicle subsystem; the communication subsystem; the user subsystem; and/or a supporting subsystem) to provide automated driving functions (e.g., sensing, prediction, planning, and/or control). In some embodiments, VDCM methods comprise allocating driving intelligence to the vehicle subsystem to complete driving tasks (e.g., sensing, prediction, planning, and/or control). In some embodiments, VDCM methods comprise identifying a vehicle having insufficient driving intelligence to complete automated driving tasks (e.g., sensing, prediction, planning, and/or control). Accordingly, in some embodiments, the VDCM is configured to integrate, combine, and/or fuse information in a vehicle-centric way to provide automated driving support to vehicles based on their prerequisites and characteristics (e.g., automation level, brand, model year, model) and/or scenarios. In some embodiments, the VDCM method comprises receiving information from a subsystem (e.g., road subsystem; vehicle subsystem; user subsystem; communication subsystem; and/or supporting subsystem); and using the information received from the subsystem to allocate resources to a vehicle to complete driving tasks (e.g., sensing, prediction, planning, and/or control). In some embodiments, VDCM methods comprise using the information received from the subsystem to identify a vehicle that has insufficient resources to complete driving tasks (e.g., sensing, prediction, planning, and/or control). In some embodiments, VDCM methods comprise using the information received from the subsystem to identify a vehicle that requires an allocation of resources to the vehicle to complete driving tasks (e.g., sensing, prediction, planning, and/or control). In some embodiments, VDCM methods comprise using the information received from the subsystem to identify a vehicle that requires an allocation of resources to the vehicle to complete driving tasks (e.g., to provide adequate resources to the vehicle to complete driving tasks (e.g., sensing, prediction, planning, and/or control)). Accordingly, in some embodiments, the VDCM method comprises receiving information from a subsystem (e.g., road subsystem; vehicle subsystem; user subsystem; communication subsystem; and/or supporting subsystem); and allocating resources to a vehicle, e.g., to complete driving tasks (e.g., to provide adequate resources to the vehicle to complete driving tasks (e.g., sensing, prediction, planning, and/or control)). In some embodiments, the VDCM method comprises requesting resources for a vehicle to complete driving tasks (e.g., sensing, prediction, planning, and/or control). In some embodiments, the VDCM method comprises proactively requesting resources for a vehicle to complete driving tasks (e.g., sensing, prediction, planning, and/or control). In some embodiments, the VDCM method comprises identifying future resources needed for a vehicle to complete driving tasks (e.g., sensing, prediction, planning, and/or control). In some embodiments, the VDCM method comprises predicting future resources needed for a vehicle to complete driving tasks (e.g., sensing, prediction, planning, and/or control). In some embodiments, the VDCM method comprises modeling future resources needed for a vehicle to complete driving tasks (e.g., sensing, prediction, planning, and/or control). In some embodiments, VDCM methods comprise identifying vehicle control instructions for a vehicle to execute.

In some embodiment, CADS comprises a cloud subsystem. In some embodiments, the cloud subsystem comprises a macroscopic cloud, a mesoscopic cloud, and/or a microscopic cloud. In some embodiments, the cloud subsystem communicates with a macroscopic cloud, a mesoscopic cloud, a microscopic cloud, and/or a VIU. In some embodiments, cloud subsystem communication (e.g., with a macroscopic cloud, mesoscopic cloud, microscopic cloud, and/or VIU) is supported by the communication subsystem, e.g., to provide low-latency data and/or information collection and transmission.

In some embodiments, a macroscopic cloud comprises a real-time simulation subsystem. In some embodiments, the macroscopic cloud is provided by a TOC. In some embodiments, the real-time simulation subsystem provides a model for global vehicle control and/or traffic management. In some embodiments, the cloud subsystem is supported by the real-time simulation subsystem (e.g., provided by the macroscopic cloud (e.g., a macroscopic cloud provided a TOC)), e.g., configured to provide global vehicle control and/or traffic management. In some embodiments, the cloud subsystem is supported by the real-time simulation subsystem (e.g., provided by the macroscopic cloud (e.g., a macroscopic cloud provided a TOC)), e.g., configured to provide data storage and information backup from regional TCC and/or corridor TCC. In some embodiments, the cloud subsystem is supported by the real-time simulation subsystem (e.g., provided by the macroscopic cloud (e.g., a macroscopic cloud provided a TOC)), e.g., configured to provide vehicle control and/or traffic management targets to regional TCC and/or corridor TCC.

In some embodiments, a mesoscopic cloud comprises an edge computing subsystem. In some embodiments, the mesoscopic cloud is provided by regional TCC and/or corridor TCC. In some embodiments, the edge computing subsystem provides low-power consumption and/or high-speed computation. In some embodiments, the cloud subsystem is supported by the edge computing subsystem (e.g., provided by the mesoscopic cloud (e.g., a mesoscopic cloud provided by a regional TCC and/or corridor TCC), e.g., configured to provide low-power consumption and/or high-speed computation. In some embodiments, the cloud subsystem is supported by the edge computing subsystem (e.g., provided by the mesoscopic cloud (e.g., a mesoscopic cloud provided by a regional TCC and/or corridor TCC), e.g., configured to provide data storage and information backup from TCU and/or RIU. In some embodiments, the cloud subsystem is supported by the edge computing subsystem (e.g., provided by the mesoscopic cloud (e.g., a mesoscopic cloud provided by a regional TCC and/or corridor TCC), e.g., configured to provides vehicle control and/or traffic management targets to TCU and/or RIU.

In some embodiments, a microscopic cloud is provided by a TCU and/or RIU. In some embodiments, the microscopic cloud (e.g., a microscopic cloud provided by a TCU and/or RIU) is configured to provide data storage and information backup for VIU of vehicles. In some embodiments, the microscopic cloud (e.g., a microscopic cloud provided by a TCU and/or RIU) is configured to provide control instructions to VIU of vehicles.

In some embodiments, the CADS comprises a vehicle subsystem. In some embodiments, the vehicle subsystem receives information from other subsystems (e.g., one or more of a cooperative management subsystem; a road subsystem; a vehicle subsystem; a communication subsystem; a user subsystem; and/or a supporting subsystem) and is configured to provide support for vehicles to perform automated driving tasks (e.g., sensing, prediction, planning, and/or control). In some embodiments, the vehicle subsystem is configured to provide support for vehicles having any automation level, a range of brands, a range of model years, and/or a range of models. In some embodiments, the vehicle subsystem is configured to provide support for vehicles having any automation level, any brand, any model year, and/or any model. In some embodiments, the vehicle subsystem comprise a vehicle adapter and/or a Vehicle Intelligent Unit (VIU). In some embodiments, the vehicle adapter is configured to manage and communicate information and/or data between a vehicle, CADS subsystems, road infrastructure, the user, and/or other supporting systems. In some embodiments, The VIU manages the automated driving functions (e.g., sensing, prediction, planning, and/or control). In some embodiments, the VIU manages the longitudinal and lateral operation of vehicles having any automation level, a range of brands, a range of model years, and/or a range of models. In some embodiments, the VIU manages the longitudinal and lateral operation of vehicles having any automation level, any brand, any model year, and/or any model.

In some embodiments, the road subsystem is configured to exchange (e.g., send and/or receive) information with the Cooperative Management (CM) subsystem, other road subsystems, vehicle subsystem, user subsystem, and/or supporting systems. In some embodiments, the road subsystem is configured to complement, enhance, elevate, backup, and/or replace automated driving functions for vehicles (e.g., sensing, prediction, planning, and control). In some embodiments, the road subsystem is configured to complement, enhance, elevate, backup, and/or replace vehicle control functions (e.g., longitudinal and lateral vehicle control and operation) for specific vehicles having any automation level, any brand or a range of different brands, any year or a range of different model years, and/or any model or a range of different models.

In some embodiments, the CADS comprises a user subsystem. In some embodiments, the user subsystem comprises a user. In some embodiments, the user is a driver and/or a passenger. In some embodiments, the user uses the user subsystem to obtain information. In some embodiments, the user subsystem obtains information from other subsystems (e.g., one or more of a cooperative management subsystem; a road subsystem; a vehicle subsystem; a communication subsystem; and/or a supporting subsystem). In some embodiments, the user subsystem obtains information from a cloud subsystem and/or a map subsystem. In some embodiments, the user subsystem provides information. In some embodiments, the user subsystem provides information from other subsystems (e.g., one or more of a cooperative management subsystem; a road subsystem; a vehicle subsystem; a communication subsystem; and/or a supporting subsystem), e.g., to a user. In some embodiments, the user subsystem provides information from a cloud subsystem and/or a map subsystem to a user. In some embodiments, the user subsystem obtains and/or provides information (e.g., to a user) that is pre-trip information (e.g., trip profile planning information), en-route information (e.g., path switching information), and/or post-trip information (e.g., feedback information, feedback and/or data storage, and/or backup). In some embodiments, the user subsystem obtains and/or provides information (e.g., to a user) comprising pre-trip, en-route, and/or post-trip notifications and/or services. In some embodiments, the user is a driver that perform emergency control of a vehicle when the vehicle encounters an emergency and/or long-tail situation. In some embodiments, the user is a driver that perform emergency control of a vehicle at an automation level less than V4 when the vehicle encounters an emergency and/or long-tail situation. In some embodiments, an administrator of the user subsystem receives information from other subsystems (e.g., one or more of a cooperative management subsystem; a road subsystem; a vehicle subsystem; a communication subsystem; a cloud subsystem; a map subsystem; and/or a supporting subsystem) and/or sends information to other subsystems (e.g., one or more of a cooperative management subsystem; a road subsystem; a vehicle subsystem; a communication subsystem; a cloud subsystem; a map subsystem; and/or a supporting subsystem), e.g., to manage and control the transportation system or the CADS at the mesoscopic and macroscopic levels.

In some embodiments, the CADS comprises a map subsystem. In some embodiments, the supporting subsystem comprises the map subsystem. In some embodiments, the map subsystem comprises a navigation module, a position or location identification module, and/or a dynamic sensing and planning module. In some embodiments, the map subsystem is configured to integrate information from other subsystems (e.g., a cooperative management subsystem; a road subsystem; a vehicle subsystem; a communication subsystem; a user subsystem; and/or a supporting subsystem (e.g., one or more subsystems of the supporting subsystem)), e.g., to support automated driving functions (e.g., navigation, positioning or location identification, and/or dynamic sensing and route planning, e.g., as provided by the navigation module, a position or location identification module, and/or a dynamic sensing and planning module, respectively). In some embodiments, information is exchanged (e.g., bidirectionally) between the map subsystem and the vehicle subsystem and/or the road subsystem. In some embodiments, information exchange complements and/or enhances the functions of the CADS and CADS subsystems. For example, in some embodiments, the navigation module of the map subsystem shares information with a planning module of the vehicle subsystem and/or road subsystem; the positioning or location identification module shares information with a sensing module; and/or the dynamic sensing and planning module shares information with the sensing, prediction, and planning functional modules.

In some embodiments, information flow between the map subsystem and the user subsystem is a unidirectional information transmission, which enhances the service and user experience of the user subsystem. For example, in some embodiments, information is transmitted to the user subsystem from a map subsystem module (e.g., navigation module, a position or location identification module, and/or a dynamic sensing and planning module) for use by a user. Accordingly, a user uses functions of the map subsystem using the vehicle subsystem. In some embodiments, the information flow between the map subsystem and the cloud subsystem is bidirectional information transmission that completes and/or enhances the functions of various modules. For example, in some embodiments, the map subsystem navigation module shares information with the macroscopic cloud and mesoscopic cloud module in the cloud subsystem; the positioning or location identification module shares information with the macroscopic cloud, mesoscopic cloud, and/or microscopic cloud; and/or the dynamic sensing and planning module shares information with the mesoscopic cloud and microscopic cloud module.

In some embodiments, the communication subsystem comprises a V2X (Vehicle-to-Everything) communication module, an I2X (Infrastructure-to-Everything) communication module, a P2X (People-to-Everything) communication module, a M2X (Map-to-Everything) communication module, and/or a C2X (Cloud-to-Everything) communication module. In some embodiments, the V2X (Vehicle-to-Everything) communication module, the I2X (Infrastructure-to-Everything) communication module, the P2X (People-to-Everything) communication module, the M2X (Map-to-Everything) communication module, and/or the C2X (Cloud-to-Everything) communication module supports a vehicle subsystem, road subsystem, user subsystem, map subsystem, and/or cloud system, e.g., to provide communicate among subsystems. In some embodiments, vehicle information (e.g., sensing, planning, and vehicle control information) and/or road information (e.g., provided by the road subsystem) is shared with a subsystem (e.g., cooperative management subsystem; road subsystem; vehicle subsystem; communication subsystem; user subsystem; and/or a supporting subsystem). In some embodiments, vehicle information (e.g., sensing, planning, and vehicle control information) and/or road information (e.g., provided by the road subsystem) is shared with a first subsystem (e.g., cooperative management subsystem; road subsystem; vehicle subsystem; communication subsystem; user subsystem; and/or a supporting subsystem) upon request by a second subsystem. In some embodiments, the communication subsystem is configured to communicate using a variety of communication technology standards, e.g., DSRC, 4G, 5G, 6G, V2X, and/or I2X (e.g., to provide communication in different communication environments). In some embodiments, the communication subsystem comprises one or more P2X, M2X, and/or C2X communication technology modules, e.g., to provide communications functions for the user subsystem, map subsystem, and/or cloud subsystem, respectively. In some embodiments, the communication subsystem comprises one or more P2X, M2X, and/or C2X communication technology modules, e.g., to provide communications functions for the user subsystem, map subsystem, and/or cloud subsystem, respectively, to send messages, data, and/or information to other subsystems (e.g., upon request).

Although the disclosure herein refers to certain illustrated embodiments, it is to be understood that these embodiments are presented by way of example and not by way of limitation.

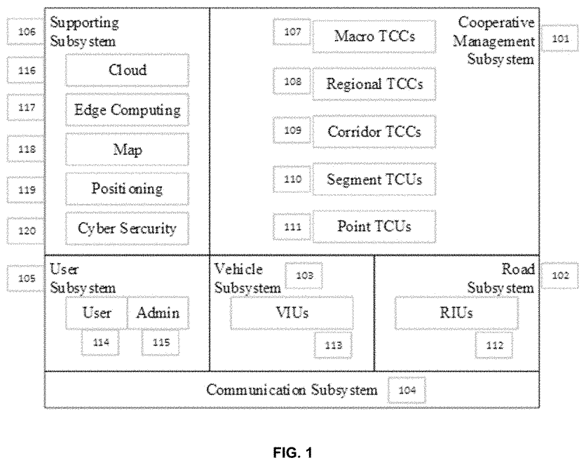

In some embodiments, e.g., as shown in FIG. 1, the technology provides a collaborative automated driving system (CADS) comprising a number of subsystems and/or modules arranged with a specific architecture and design. The CADS comprises a cooperative management (CM) subsystem 101, a road subsystem 102, a vehicle subsystem 103, a communication subsystem 104, a user subsystem 105, and/or a supporting subsystem 106. The CM subsystem comprises macroscopic traffic control centers (TCC) 107, regional TCC 108, corridor TCC 109, segment traffic control units (TCU) 110, and/or point TCU 111. As shown in FIG. 1, the hierarchical structure design of TCC and TCU is used to fuse, process, and/or store collected data and information, e.g., to provide efficient coordination with other subsystems. The Road Intelligent Units (RIUs) 112 (e.g., provided by the road subsystem) are designed to enhance, complete, and/or support automated driving functions (e.g., sensing, prediction, planning, and control). Similarly, the vehicle intelligent units (VIUs) 113 are designed to enhance, complete, and/or support automated driving functions (e.g., sensing, prediction, planning, and control) and are implemented in connected and automated vehicles. The user subsystem is defined by two categories of users: 1) a vehicle user 114 (e.g., a passenger and/or a driver); and 2) an administrator 115. The supporting system, which provides physical and technical support for the transportation services provided by other subsystems, comprises cloud system 116, edge computing system 117, map system 118, high-precision positioning system 119, and/or cybersecurity system 120.

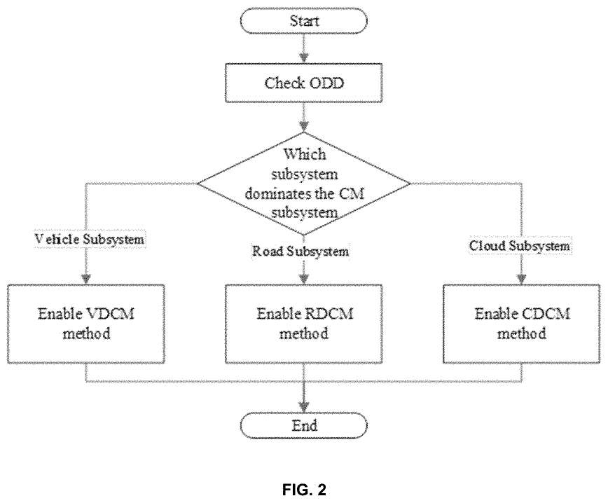

In some embodiments, e.g., as shown in FIG. 2, the technology provides binding methods. In some embodiments, the CM subsystem is configured to perform a binding method. In some embodiments, binding methods comprise checking (e.g., by the CADS) the Operation Design Domain (ODD) of the request site or corridor; and determining (e.g., by the CADS) which subsystem dominates the CM subsystem, e.g., using information describing the specific parameters provided by the ODD (e.g., as system intelligence level, user preference, geometric information, vehicle automation level, etc.). If the vehicle subsystem is chosen to dominate the CM subsystem, methods comprise enabling (e.g., performing by the CADS) a vehicle-dominant CM method for completing further automated driving tasks. If the road subsystem is chosen to dominate the CM subsystem, methods comprise enabling (e.g., performing by the CADS) a road-dominant CM method for completing further automated driving tasks. If the cloud subsystem is chosen to dominate the CM subsystem, methods comprise enabling (e.g., performing by the CADS) a cloud-dominant CM method for completing further automated driving tasks.

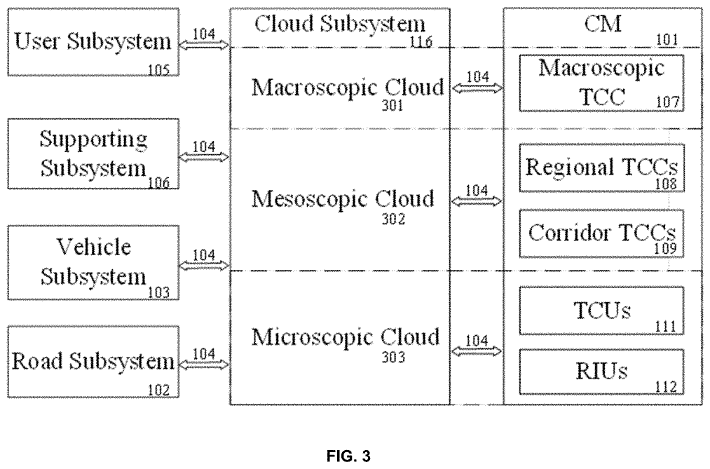

In some embodiments, e.g., as shown in FIG. 3, the CADS technology provides and/or comprises a cloud subsystem 116. The cloud subsystem comprises a macroscopic cloud 301, a mesoscopic cloud 302, and/or a microscopic cloud 303. In some embodiments, the macroscopic cloud 301 is associated with a macroscopic TCC 107 in CM subsystem 101. In some embodiments, the macroscopic cloud 301 communicates with a macroscopic TCC 107 in CM subsystem 101. In some embodiments, the macroscopic cloud 301 provides support to a macroscopic TCC 107 in CM subsystem 101. In some embodiments, the macroscopic TCC 107 provides and/or comprises the macroscopic cloud 301 (e.g., in some embodiments, the macroscopic TCC 107 comprises one or more computers configured to provide the macroscopic cloud 301). In some embodiments, the mesoscopic cloud 302 is associated with a regional TCC 108 and/or corridor TCC 109 in CM subsystem 101. In some embodiments, the mesoscopic cloud 302 communicates with a regional TCC 108 and/or corridor TCC 109 in CM subsystem 101. In some embodiments, the mesoscopic cloud 302 provides support to a regional TCC 108 and/or corridor TCC 109 in CM subsystem 101. In some embodiments, the regional TCC 108 and/or corridor TCC 109 provides and/or comprises the mesoscopic cloud 302 (e.g., in some embodiments, the regional TCC 108 and/or corridor TCC 109 comprises one or more computers configured to provide the mesoscopic cloud 302). In some embodiments, the microscopic cloud 303 is associated with a TCU 111 and/or RIU 112 in CM subsystem 101. In some embodiments, the microscopic cloud 303 communicates with a TCU 111 and/or RIU 112 in CM subsystem 101. In some embodiments, the microscopic cloud 303 provides support to a TCU 111 and/or RIU 112 in CM subsystem 101. In some embodiments, the TCU 111 and/or RIU 112 provides and/or comprises the microscopic cloud 303 (e.g., in some embodiments, the TCU 111 and/or RIU 112 comprises one or more computers configured to provide the microscopic cloud 303). The CM subsystem 101 is connected with the User subsystem 105, Supporting subsystem 106, Vehicle subsystem 103, and/or Road subsystem 102 using the Cloud subsystem 116 via communication subsystem 104. The User subsystem 105 provides services to individuals who are of type administrator and/or user. In some embodiments, an administrator supervises the Cloud subsystem 116 by using information from macroscopic cloud 301, mesoscopic cloud 302, and/or microscopic cloud 303; and sends instructions to macroscopic cloud 301, mesoscopic cloud 302, and/or microscopic cloud 303 to manage the cloud subsystem 116. In some embodiments, the user sends profile information and feedback to cloud subsystem 116 and uses information from cloud subsystem 116 to help the cloud subsystem 116 improve service. The Cloud subsystem 116 retrieves information from supporting subsystem 106 and/or user subsystem 105 in CDCM.

The cloud subsystem 116 and vehicle subsystem 103 exchange information (e.g., using communication subsystem 104). In some embodiments, the cloud subsystem 116 identifies vehicles needing assistance (e.g., the cloud subsystem 116 identifies vehicles having inadequate resources to perform driving tasks). In some embodiments, the cloud subsystem 116 provides resources (e.g., information and instructions) to vehicles needing assistance. In some embodiments, resources are provided to a vehicle needing assistance based on the vehicle intelligence level of the vehicle needing assistance (e.g., to increase the vehicle intelligence level as appropriate for the driving tasks required). The cloud subsystem 116 and road subsystem 102 exchange information (e.g., using communication subsystem 104). In some embodiments, the cloud subsystem 116 identifies components of the road infrastructure needing assistance (e.g., the cloud subsystem 116 identifies components of the road infrastructure having inadequate resources to perform driving tasks). In some embodiments, the cloud subsystem 116 provides resources (e.g., information and instructions) to components of the road infrastructure needing assistance. In some embodiments, resources are provided to the components of the road infrastructure needing assistance based on the infrastructure intelligence level of the components of the road infrastructure needing assistance (e.g., to increase the infrastructure intelligence level as appropriate for the road infrastructure to support vehicles to perform driving tasks required).

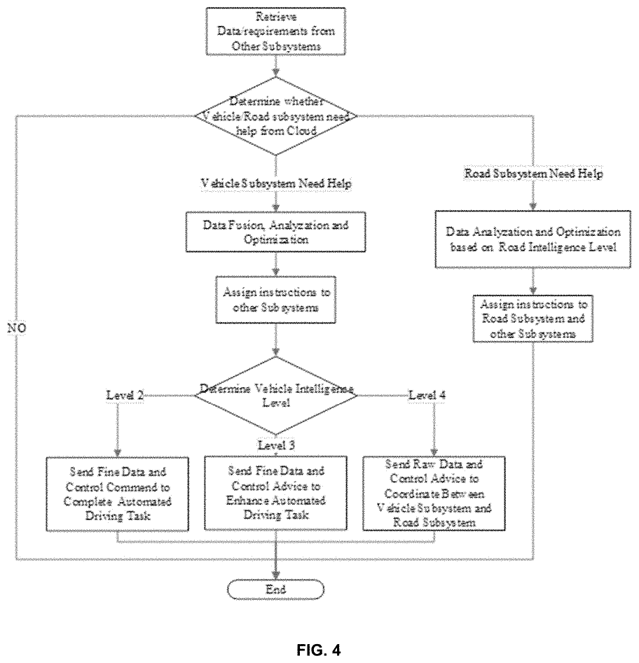

In some embodiments, e.g., as shown in FIG. 4, the technology provides a CDCM method. In some embodiments, the CADS is configured to perform a CDCM method. The CDCM method comprises retrieving (e.g., by the cloud subsystem) data and/or requests from a subsystem (e.g., a cooperative management subsystem; a road subsystem; a vehicle subsystem; a communication subsystem; a user subsystem; and/or a supporting subsystem). Next, the CDCM method comprises determining (e.g., by the cloud subsystem) if the vehicle subsystem and/or road subsystem requires assistance (e.g., the cloud subsystem 116 determines if the vehicle subsystem and/or road subsystem has inadequate resources to perform driving tasks). If the road subsystem requires assistance (e.g., resources), methods comprise analyzing data (e.g., by the cloud subsystem) and/or optimizing (e.g., by the cloud subsystem) data based on the road infrastructure intelligence level. In some embodiments, methods comprise assigning (e.g., by the cloud subsystem) instructions to the road subsystem and/or to other subsystems. If the vehicle subsystem requires assistance (e.g., resources), methods comprise fusing, analyzing, and/or optimizing (e.g., by the cloud subsystem) data. In some embodiments, methods comprise assigning (e.g., by the cloud subsystem) instructions to other subsystems. For CAV having a high intelligence level (e.g., V4 or greater), methods comprise providing (e.g., by the cloud subsystem) raw data and/or vehicle control advice to provide vehicle control by the coordination of the vehicle subsystem and the road subsystem. For CAV having an intelligence level of V3, methods comprise providing (e.g., by the cloud subsystem) processed data and control advice to enhance automated driving tasks. For CAV having a low intelligence level (e.g., V2 or less), methods comprise providing (e.g., by the cloud subsystem) processed data and control commands to complete the automated driving tasks. In some embodiments, the CDCM methods are configured for the specific needs of the road subsystem or vehicle subsystem. For example, in some embodiments, the cloud subsystem performs different methods for the vehicle subsystem and the road subsystem in some scenarios. In particular, the CDCM methods for the road subsystem comprise collecting (e.g., by the cloud subsystem) data and sending (e.g., by the cloud subsystem) the entire data set to the road subsystem. The CDCM methods for the vehicle subsystem comprise collecting (e.g., by the cloud subsystem) data and sending (e.g., by the cloud subsystem) data that is appropriate and/or required by a vehicle according to the intelligence level of the vehicle (e.g., the cloud subsystem tailors the data as appropriate to provide assistance to the vehicle according to the intelligence level of the vehicle).

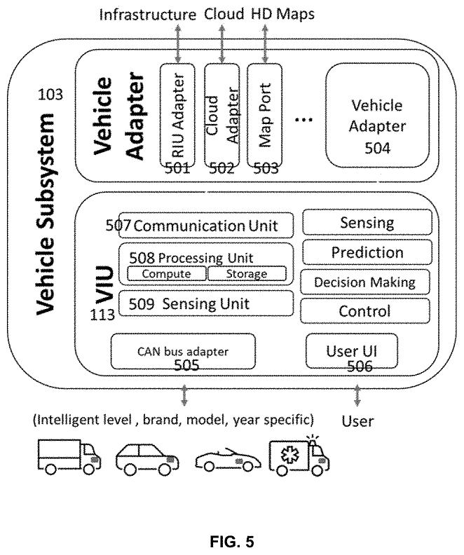

In some embodiments, e.g., as shown in FIG. 5, the CADS technology comprises and/or provides a vehicle subsystem 103. In some embodiments, the vehicle subsystem 103 comprises a vehicle adapter 504 and a VIU 113. The vehicle adapter 504 is configured to connect and adapt the VIU 113 with other subsystems and/or CADS components. For example, in some embodiments, the vehicle adapter 504 is configured to connect and adapt the VIU 113 with road infrastructure (e.g., RIU), the cloud subsystem, and/or a high-definition map through the RIU adapter 501, cloud adapter 502, and/or map port 503, respectively. The VIU comprises a communication unit 507, a processing unit 508, and/or a sensing unit 509. In some embodiments, the VIU provides automated driving for a vehicle, e.g., the VIU provides sensing, prediction, planning, and/or control for a vehicle. In some embodiments, the VIU adapts to a vehicle controller area network (CAN) bus through a CAN bus adapter 505 and communicates with the vehicle user through the user interface 506.

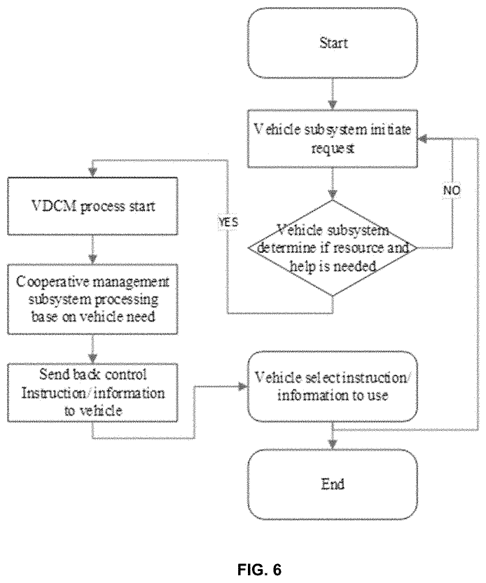

In some embodiments, e.g., as shown in FIG. 6, the technology provides a VDCM method. In some embodiments, the CADS is configured to perform a VDCM method. The VDCM method comprises determining (e.g., by a vehicle) whether to use the resources from the CADS, e.g., determining (e.g., by a vehicle) if the vehicle requires resources from the CADS to perform driving tasks. For example, vehicles at a high intelligence level (e.g., V4 or greater) receive high-level instructions and/or information from CADS most of the time and receive detailed information and/or vehicle control instructions in extreme conditions and/or long-tail scenarios when requested by the vehicle and/or as determined by the CADS. Accordingly, embodiments provide methods comprising receiving (e.g., by a vehicle (e.g., a CAV at V4 or higher)) general high-level instructions and/or information from CADS. In some embodiments, methods comprise requesting (e.g., by a vehicle (e.g., a CAV at V4 or higher)) detailed information and/or vehicle control instructions from CADS and receiving (e.g., a CAV at V4 or higher)) detailed information and/or vehicle control instructions from CADS, e.g., when the vehicle is driving in extreme conditions and/or long-tail scenarios. Related embodiments provide methods comprising providing (e.g., by CADS) general high-level instructions and/or information (e.g., to a vehicle (e.g., a CAV at V4 or higher)). In some embodiments, methods comprise receiving (e.g., by CADS) a request (e.g., from a vehicle (e.g., a CAV at V4 or higher)) for detailed information and/or vehicle control instructions and providing (e.g., by CADS) detailed information and/or vehicle control instructions (e.g., to a vehicle (e.g., a CAV at V4 or higher)), e.g., when the vehicle is driving in extreme conditions and/or long-tail scenarios. In some embodiments, vehicles at a low intelligence level (e.g., V2 or lower) receive control instructions from CADS to perform driving tasks. For example, in some embodiments, the vehicle subsystem determines that a vehicle at a low intelligence level (e.g., a vehicle with automatic cruise control and/or lane keeping ability) requires assistance to perform driving tasks and chooses to provide vehicle control by CADS to the vehicle at a low intelligence level, e.g., the CADS provides vehicle control instructions to the vehicle. Accordingly, embodiments provide methods comprising determining (e.g., by the vehicle subsystem) that a vehicle has a low intelligence level (e.g., V2 or less). In some embodiments, methods comprise providing vehicle control (e.g., by the vehicle subsystem) to the vehicle, e.g., by providing vehicle control instructions from CADS to the vehicle.

In some embodiments, the CADS technology provides and/or comprises a Roadside Intelligent Unit (RIU). In some embodiments, the road subsystem provides and/or comprises the RIU. In some embodiments, the RIU provides and/or comprises the road subsystem. The RIU comprises a cloud subsystem adapter (e.g., cloud adapter) 701, a CADS adapter (e.g., system adapter 702), a vehicle subsystem adapter (e.g., VIU adapter 706), a user subsystem adapter (e.g., user interface adapter 707), and/or a map subsystem adapter (e.g., map port 708). The RIU comprises a sensing unit 703, a processing unit 704, and/or a communications unit 708. In some embodiments, the sensing unit 703, the processing unit 704, and/or the communications unit 708 provide support to the RIU to support driving tasks for vehicles. For example, in some embodiments, the RIU provides support to vehicles to perform automated driving tasks e.g., sensing, prediction, planning, and/or control (e.g., (longitudinal and lateral operation)). In some embodiments, the RIU provides specifically tailored support for a specific vehicle based on the vehicle intelligence level, vehicle brand, vehicle model year, and/or vehicle model. Accordingly, the RIU is configured to provide support to vehicles having any intelligence level, any vehicle brand or a range of vehicle brands, any vehicle model year or a range of vehicle model years, and/or any vehicle model or a range of vehicle models.

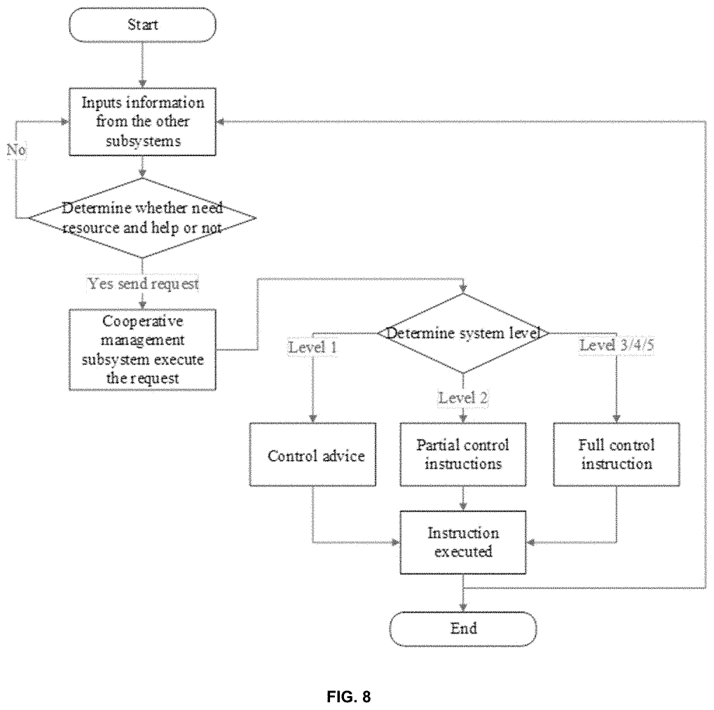

In some embodiments, e.g., as shown in FIG. 8, the technology provides RDCM methods. In some embodiments, the CADS is configured to perform an RDCM method. In some embodiments, the road subsystem and/or road infrastructure (e.g., a component of road infrastructure) is configured to perform an RDCM method. In some embodiments, the CM subsystem is configured to perform RDCM methods. In some embodiments, RDCM methods comprise collecting inputs (e.g., data and/or information). In some embodiments, inputs (e.g., data and/or information) are collected from a subsystem or a number of subsystems (e.g., one or more of a cooperative management subsystem; a road subsystem; a vehicle subsystem; a communication subsystem; a user subsystem; and/or a supporting subsystem). Accordingly, in some embodiments, methods comprise collecting inputs (e.g., data and/or information) from a subsystem or a number of subsystems (e.g., one or more of a cooperative management subsystem; a road subsystem; a vehicle subsystem; a communication subsystem; a user subsystem; and/or a supporting subsystem). The methods comprise deciding if resources are adequate for vehicles to perform driving tasks or if resources are inadequate for vehicles to perform driving tasks. If resources are adequate, methods comprise further collecting inputs (e.g., data and/or information) from a subsystem or a number of subsystems (e.g., one or more of a cooperative management subsystem; a road subsystem; a vehicle subsystem; a communication subsystem; a user subsystem; and/or a supporting subsystem). If resources are inadequate, methods comprise sending a request (e.g., from the road subsystem and/or road infrastructure (e.g., a component of road infrastructure)) to the CM subsystem for resources. In some embodiments, the CM subsystem executes the request for resources, e.g., methods comprise sending (e.g., by the CM subsystem) resources to the road subsystem and/or road infrastructure (e.g., a component of road infrastructure)). In some embodiments, methods comprise determining the intelligence level of the CADS and sending instructions accordingly. For instance, if the CADS intelligence level is 1, RDCM methods comprise sending control advice; if the CADS intelligence is 2, RDCM methods comprise sending partial vehicle control instructions; if the CADS intelligence level is 3, 4, or 5, RDCM methods comprise sending complete vehicle control instructions. Then, RDCM methods comprise executing control instructions (e.g., by a vehicle).

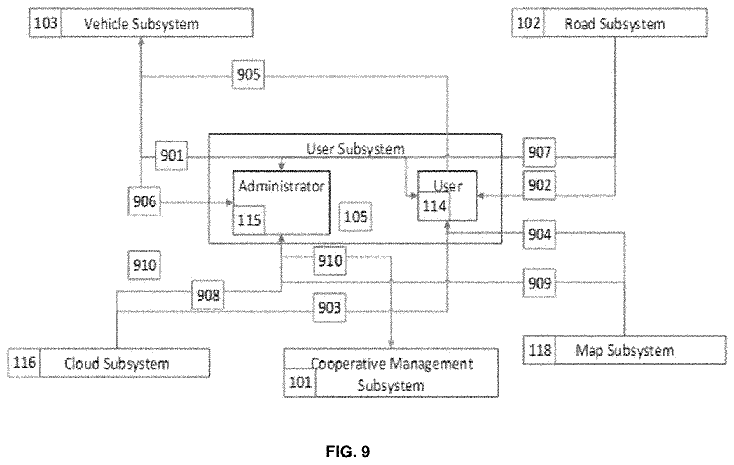

In some embodiments, e.g., as shown in FIG. 9, the CADS provides and/or comprises a user subsystem comprising information and/or data flows. In some embodiments, the user subsystem 105 comprises a user 114 and/or an administrator 115. In some embodiments, the user subsystem 105 finds use by a user 114 and/or by an administrator 115. For example, in some embodiments, a vehicle user 114 receives information (901, 902, 903, 904) from other subsystems (e.g., vehicle subsystem 103, road subsystem 102, and other supporting systems (e.g., cloud subsystem 116 and map subsystem 118)) and provides vehicle control when necessary to complete driving tasks. Further, in some embodiments, an administrator user 115 receives information (906, 907, 908, 909) from other subsystems (e.g., cooperative management subsystem 101, road subsystem 102, vehicle subsystem 103, and other supporting systems (e.g., cloud subsystem 116 and map subsystem 118)) and sends information 910 to other subsystems (e.g., cooperative management subsystem 101, road subsystem 102, vehicle subsystem 103, and other supporting systems (e.g., cloud subsystem 116 and map subsystem 118)). In some embodiments, the administrator 115 sends information 910 to other subsystems (e.g., cooperative management subsystem 101, road subsystem 102, vehicle subsystem 103, and other supporting systems (e.g., cloud subsystem 116 and map subsystem 118)) for vehicle control and/or traffic management.

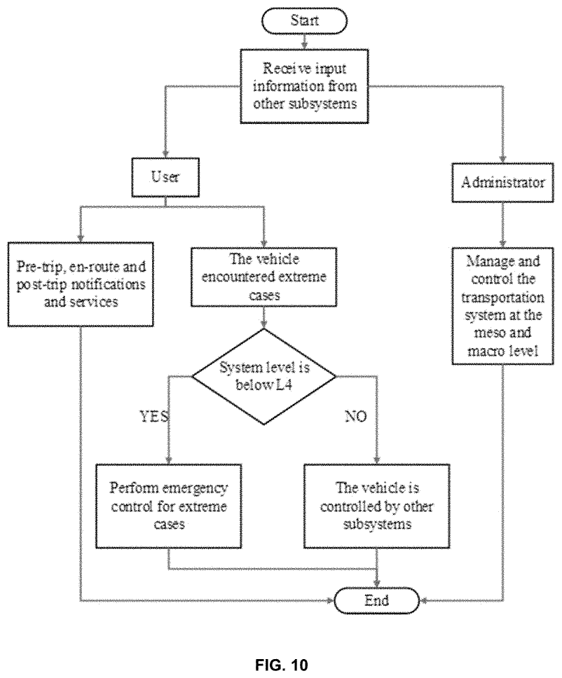

In some embodiments, e.g., as shown in FIG. 10, the technology provides user subsystem methods. In some embodiments, the user subsystem is configured to perform a user subsystem method. In some embodiments, a user performs one or more steps of a user subsystem method. In some embodiments, the user subsystem comprises a user. In some embodiments, methods comprise receiving (e.g., by a user) data and/or information from other subsystems (e.g., a cooperative management subsystem; a road subsystem; a vehicle subsystem; a communication subsystem; a user subsystem; and/or a supporting subsystem). In some embodiments, methods comprise receiving (e.g., by a user) data and/or information relating to pre-trip notifications and services, en-route notifications and services, and/or post-trip notifications and services. If the CADS level of automation is below level 4, methods comprise performing (e.g., by a user) emergency control of a vehicle when the vehicle encounters extreme cases and/or long-tail scenarios. If the CADS level of automation is 4 or more, methods comprise controlling the vehicle by CADS (e.g., by a CADS subsystem). In some embodiments, methods comprise sending (e.g., by an administrator user) information to other subsystems (e.g., a cooperative management subsystem; a road subsystem; a vehicle subsystem; a communication subsystem; a user subsystem; and/or a supporting subsystem). In some embodiments, methods comprise managing (e.g., by an administrator user) traffic and/or controlling (e.g., by an administrator user) vehicles to provide a cooperative vehicle and traffic management system. In some embodiments, methods comprise managing (e.g., by an administrator user) traffic and/or controlling (e.g., by an administrator user) vehicles to provide a cooperative vehicle and traffic management system at a mesoscopic and/or macroscopic level based on information received from one or more subsystems.

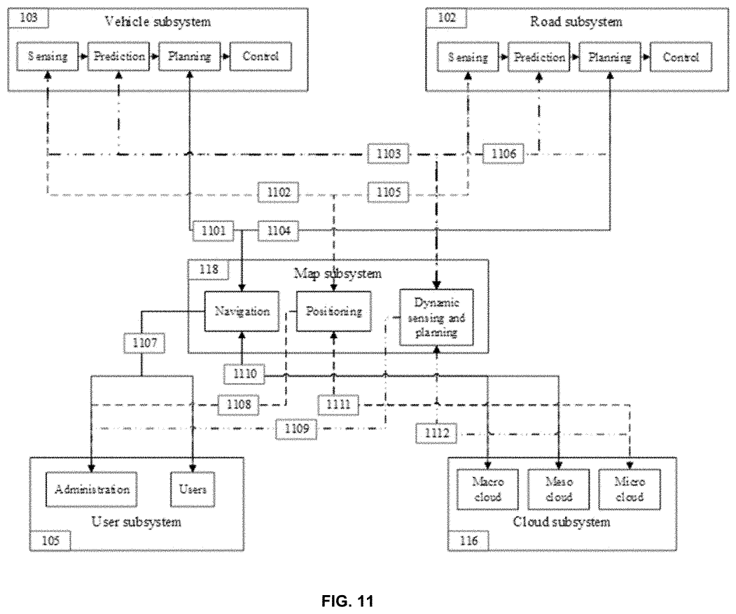

In some embodiments, e.g., as shown in FIG. 11, the CADS provides and/or comprises data and/or information flows (e.g., exchange). In some embodiments, the CADS provides and/or comprises data and/or information flows (e.g., exchange) between the map subsystem 118 and vehicle subsystem 103; between the map subsystem 118 and the road subsystem 102; between the map subsystem 118 and the user subsystem 105; and/or between the map subsystem 118 and the cloud subsystem 116. In some embodiments, information flow (e.g., exchange) is bidirectional between the map subsystem 118 and the vehicle subsystem 103. In particular, in some embodiments, information flow (e.g., exchange) is bidirectional between the map subsystem navigation module and the vehicle subsystem planning functional module 1101; between the map subsystem positioning function module and the vehicle subsystem sensing functional module 1102; and between the map subsystem dynamic sensing and planning module and each of the vehicle subsystem sensing, prediction, and planning functional modules 113. Similarly, in some embodiments, information flow (e.g., exchange) is bidirectional between the map subsystem 118 and the road subsystem 102. In particular, in some embodiments, information flow (e.g., exchange) is bidirectional between the map subsystem navigation module and the road subsystem planning functional module 1104; between the map subsystem positioning function module and the road subsystem sensing functional module 1105; and between the map subsystem dynamic sensing and planning module and each of the road subsystem sensing, prediction, and planning functional modules 1106. In some embodiments, information flow (e.g., exchange) is bidirectional between the map subsystem 118 and the user subsystem 105. In particular, in some embodiments, information flow (e.g., exchange) is bidirectional between the map subsystem navigation module and the administration and users in the user subsystem (1107); between the map subsystem positioning function module and the administration and users in the user subsystem (1108); and between the map subsystem dynamic sensing and planning module and administration and users in the user subsystem (1109).

In some embodiments, information flow (e.g., exchange) is bidirectional between the map subsystem 118 the cloud subsystem 116. In particular, in some embodiments, information flow (e.g., exchange) is bidirectional between the map subsystem navigation module and the macroscopic cloud module 1110; between the map subsystem navigation module and the mesoscopic cloud module 1110; between the map subsystem positioning function module and the macroscopic cloud module 1111; between the map subsystem positioning function module and the mesoscopic cloud module 1111; between the map subsystem positioning function module and the microscopic cloud module 1111; between the map subsystem dynamic sensing and planning module and the mesoscopic cloud module 1112; and between the map subsystem dynamic sensing and planning module and the microscopic cloud module 1112.

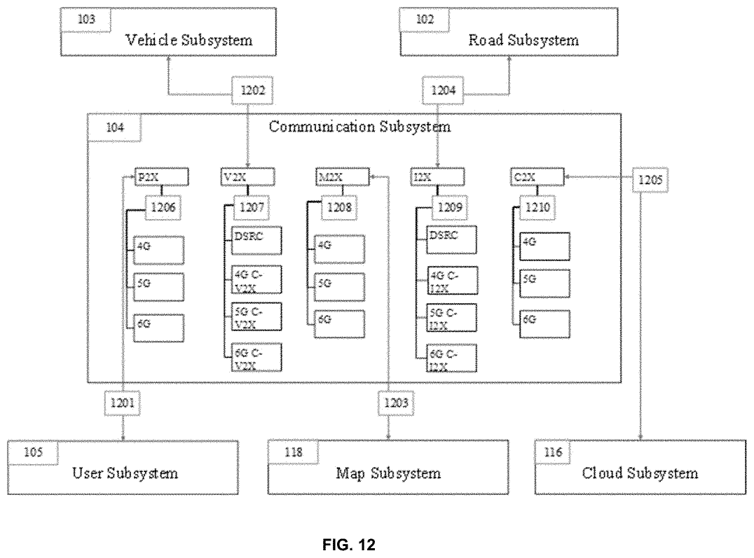

In some embodiments, e.g., as shown in FIG. 12, the CADS comprises and/or provides communication technology modules. In some embodiments, the communications subsystem 104 comprises and/or provides the communication technology modules, e.g., to provide communication services for each subsystem (e.g., vehicle subsystem 103, road subsystem 102, user subsystem 105, map subsystem 118, and/or cloud subsystem 116). In some embodiments, the vehicle subsystem 103 communicates 1202 with other subsystems through the V2X (vehicle to everything) communication technology module. In some embodiments, communication technology standards 1207 (e.g., DSRC, 4G, 5G, and/or 6G) support V2X communication. In some embodiments, the road subsystem 102 communicates 1204 with other subsystems through the I2X (infrastructure to everything) communication technology. In some embodiments, communication technology standards 1209 (e.g., DSRC, 4G, 5G, and/or 6G) support I2X communication. In some embodiments, the user subsystem 105 communicates 1201 with other subsystems through the P2X (people or pedestrian to everything) communication technology module. In some embodiments, communication technology standards 1206 (e.g., 4G, 5G, and/or 6G) support P2X communication. In some embodiments, the map subsystem 118 communicates 1203 with other subsystems through the M2X (map to everything) communication technology module. In some embodiments, communication technology standards 1208 (e.g., 4G, 5G, and/or 6G) support M2X communication. In some embodiments, the cloud subsystem 116 communicates with other subsystems 1205 through the C2X (cloud to everything) communication technology module. In some embodiments, communication technology standards 1210 (4G, 5G, and/or 6G) support C2X communication.

### Automated Driving Systems (ADS)

In some embodiments, the technology provides improvements (e.g., a CADS) for a vehicle operations and control system (e.g., a CAVH and technologies as described herein). In some embodiments, the CAVH comprises one or more of a roadside intelligent unit (RIU) network; a Traffic Control Unit (TCU), a Traffic Control Center (TCC); a TCU/TCC network; a vehicle intelligent unit (VIU) (e.g., a vehicle comprising a VIU); and/or a Traffic Operations Center (TOC). In some embodiments, the system comprises multiple kinds of sensors and computation devices on CAV and infrastructure (e.g., roadside infrastructure) and is configured to integrate sensing, prediction, planning, and control for automated driving of CAV.

In some embodiments, the technology relates to an ADS provided as a connected and automated vehicle highway (CAVH) system, e.g., comprising one or more components of an intelligent road infrastructure system (see, e.g., U.S. Pat. Nos. 10,867,512 and 10,380,886, each of which is incorporated herein by reference). In some embodiments, the ADS is provided as or supports a distributed driving system (DDS), intelligent roadside toolbox (IRT), and/or device allocation system (DAS) (see, e.g., U.S. Pat. App. Ser. Nos. 16/996,684; 63/004,551; and 63/004,564, each of which is incorporated herein by reference). In some embodiments, the term “roadside intelligent unit” and its abbreviation “RIU” are used to refer to the components named a “roadside unit” and its abbreviation “RSU”, respectively, as described for the CAVH technology in, e.g., U.S. Pat. Nos. 10,867,512 and 10,380,886, each of which is incorporated herein by reference. In some embodiments, the term “vehicle intelligent unit” and its abbreviation “VIU” are used to refer to the components named an “onboard unit” and its abbreviation “OBU”, respectively, as described for the CAVH technology in, e.g., U.S. Pat. Nos. 10,867,512 and 10,380,886, each of which is incorporated herein by reference. In some embodiments, the term “vehicle intelligent unit” and its abbreviation “VIU” are used to refer to the components named an “onboard intelligent unit” and its abbreviation “OIU”, respectively, as described in U.S. Pat. App. Ser. No. 63/042,620, incorporated herein by reference.

In some embodiments, the technology provides a system (e.g., a vehicle operations and control system comprising a RIU and/or an RIU network; a TCU/TCC network; a vehicle comprising an vehicle intelligent unit; a TOC; and/or a cloud-based platform configured to provide information and computing services (see, e.g., U.S. patent application Ser. No. 16/454,268, incorporated herein by reference)) configured to provide sensing functions, transportation behavior prediction and management functions, planning and decision making functions, and/or vehicle control functions. In some embodiments, the system comprises wired and/or wireless communications media. In some embodiments, the system comprises a power supply network. In some embodiments, the system comprises a cyber-safety and security system. In some embodiments, the system comprises a real-time communication function.

In some embodiments, the RIU network comprises an RIU subsystem. In some embodiments, the RIU subsystem comprises a sensing module configured to measure characteristics of the driving environment; a communication module configured to communicate with vehicles, TCUs, and the cloud; a data processing module configured to process, fuse, and compute data from the sensing and/or communication modules; an interface module configured to communicate between the data processing module and the communication module; and an adaptive power supply module configured to provide power and to adjust power according to the conditions of the local power grid. In some embodiments, the adaptive power supply module is configured to provide backup redundancy. In some embodiments, the communication module communicates using wired or wireless media.

In some embodiments, the sensing module comprises a radar based sensor. In some embodiments, the sensing module comprises a vision based sensor. In some embodiments, the sensing module comprises a radar based sensor and a vision based sensor and wherein the vision based sensor and the radar based sensor are configured to sense the driving environment and vehicle attribute data. In some embodiments, the radar based sensor is a LIDAR, microwave radar, ultrasonic radar, or millimeter radar. In some embodiments, the vision based sensor is a camera, infrared camera, or thermal camera. In some embodiments, the camera is a color camera.

In some embodiments, the sensing module comprises a global navigation satellite system (GNSS). In some embodiments, the sensing module comprises an inertial navigation system. In some embodiments, the sensing module comprises a satellite based navigation system and an inertial navigation system and the sensing module and/or the inertial navigation system are configured to provide vehicle location data. In some embodiments, the GNSS is, e.g., the Global Positioning System developed by the United States, Differential Global Positioning System (DGPS), BeiDou Navigation Satellite System (BDS) System, GLONASS Global Navigation Satellite System), European Union Galileo positioning system, the NavIC system of India, and the Quasi-Zenith Satellite System (QZSS) of Japan.

In some embodiments, the sensing module comprises a vehicle identification device. In some embodiments, the vehicle identification device comprises RFID, Bluetooth, Wi-fi (IEEE 802.11), or a cellular network radio, e.g., a 4G, 5G, or 6G cellular network radio.

In some embodiments, the RIU subsystem is deployed at a fixed location near a road comprising automated lanes and, optionally, human-driven lanes. In some embodiments, the RIU subsystem is deployed at a fixed location near road infrastructure. In some embodiments, the RIU subsystem is deployed near a highway roadside, a highway onramp, a highway offramp, an interchange, intersection, a bridge, a tunnel, a toll station, or on a drone over a critical location. In some embodiments, the RIU subsystem is deployed on a mobile component. In some embodiments, the RIU subsystem is deployed on a vehicle drone over a critical location, on an unmanned aerial vehicle (UAV), at a site of traffic congestion, at a site of a traffic accident, at a site of highway construction, and/or at a site of extreme weather. In some embodiments, an RIU subsystem is positioned according to road geometry, traffic amount, traffic capacity, vehicle type using a road, road size, and/or geography of the area. In some embodiments, the RIU subsystem is installed on a gantry (e.g., an overhead assembly, e.g., on which highway signs or signals are mounted). In some embodiments, the RIU subsystem is installed using a single cantilever or dual cantilever support.

In some embodiments, the TCC network is configured to provide traffic operation optimization, data processing, and archiving. In some embodiments, the TCC network comprises a human operations interface. In some embodiments, the TCC network is a macroscopic TCC, a regional TCC, or a corridor TCC based on the geographical area covered by the TCC network. See, e.g., U.S. Pat. Nos. 10,380,886; 10,867,512; 10,692,365; and U.S. Pat. App. Pub. Nos. 20200005633 and 20200021961, each of which is incorporated herein by reference.

In some embodiments, the TCU network is configured to provide real-time vehicle control and data processing. In some embodiments, the real-time vehicle control and data processing are automated based on preinstalled algorithms. In some embodiments, the TCU network comprises a segment TCU or a point TCU based on based on the geographical area covered by the TCU network. In some embodiments, the system comprises a point TCU physically combined or integrated with an RIU. In some embodiments, the system comprises a segment TCU physically combined or integrated with a RIU. See, e.g., U.S. Pat. Nos. 10,380,886; 10,867,512; 10,692,365; and U.S. Pat. App. Pub. Nos. 20200005633 and 20200021961, each of which is incorporated herein by reference.

In some embodiments, the TCC network comprises macroscopic TCCs configured to process information from regional TCCs and provide control targets to regional TCCs; regional TCCs configured to process information from corridor TCCs and provide control targets to corridor TCCs; and corridor TCCs configured to process information from macroscopic and segment TCUs and provide control targets to segment TCUs. See, e.g., U.S. Pat. Nos. 10,380,886; 10,867,512; 10,692,365; and U.S. Pat. App. Pub. Nos. 20200005633 and 20200021961, each of which is incorporated herein by reference.

In some embodiments, the TCU network comprises segment TCUs configured to process information from corridor and/or point TOCs and provide control targets to point TCUs; and point TCUs configured to process information from the segment TCU and RIUs and provide vehicle-based control instructions (e.g., detailed and time-sensitive control instructions for individual vehicles) to an RIU. See, e.g., U.S. Pat. Nos. 10,380,886; 10,867,512; 10,692,365; and U.S. Pat. App. Pub. Nos. 20200005633 and 20200021961, each of which is incorporated herein by reference.

In some embodiments, the RIU network provides vehicles with customized traffic information and control instructions (e.g., detailed and time-sensitive control instructions for individual vehicles) and receives information provided by vehicles.

In some embodiments, the TCC network comprises one or more TCCs comprising a connection and data exchange module configured to provide data connection and exchange between TCCs. In some embodiments, the connection and data exchange module comprises a software component providing data rectify, data format convert, firewall, encryption, and decryption methods. In some embodiments, the TCC network comprises one or more TCCs comprising a transmission and network module configured to provide communication methods for data exchange between TCCs. In some embodiments, the transmission and network module comprises a software component providing an access function and data conversion between different transmission networks within the cloud platform. In some embodiments, the TCC network comprises one or more TCCs comprising a service management module configured to provide data storage, data searching, data analysis, information security, privacy protection, and network management functions. In some embodiments, the TCC network comprises one or more TCCs comprising an application module configured to provide management and control of the TCC network. In some embodiments, the application module is configured to manage cooperative control of vehicles and roads, system monitoring, emergency services, and human and device interaction.

In some embodiments, TCU network comprises one or more TCUs comprising a sensor and control module configured to provide the sensing and control functions of an RIU. In some embodiments, the sensor and control module is configured to provide the sensing and control functions of radar, camera, RFID, and/or V2I (vehicle-to-infrastructure) equipment. In some embodiments, the sensor and control module comprises a DSRC, GPS, 4G, 5G, 6G, and/or wireless (e.g., IEEE 802.11) radio. In some embodiments, the TCU network comprises one or more TCUs comprising a transmission and network module configured to provide communication network function for data exchange between an automated vehicle and a RIU. In some embodiments, the TCU network comprises one or more TCUs comprising a service management module configured to provide data storage, data searching, data analysis, information security, privacy protection, and network management. In some embodiments, the TCU network comprises one or more TCUs comprising an application module configured to provide management and control methods of an RIU. In some embodiments, the management and control methods of an RIU comprise local cooperative control of vehicles and roads, system monitoring, and emergency service. In some embodiments, the TCC network comprises one or more TCCs further comprising an application module and the service management module provides data analysis for the application module. In some embodiments, the TCU network comprises one or more TCUs further comprising an application module and the service management module provides data analysis for the application module.

In some embodiments, the TOC comprises interactive interfaces. In some embodiments, the interactive interfaces provide control of the TCC network and data exchange. In some embodiments, the interactive interfaces comprise information sharing interfaces and vehicle control interfaces. In some embodiments, the information sharing interfaces comprise an interface that shares and obtains traffic data; an interface that shares and obtains traffic incidents; an interface that shares and obtains passenger demand patterns from shared mobility systems; an interface that dynamically adjusts prices according to instructions given by the vehicle operations and control system; and/or an interface that allows a special agency (e.g., a vehicle administrative office or police) to delete, change, and/or share information. In some embodiments, the vehicle control interfaces comprise an interface that allows a vehicle operations and control system to assume control of vehicles; an interface that allows vehicles to form a platoon with other vehicles; and/or an interface that allows a special agency (e.g., a vehicle administrative office or police) to assume control of a vehicle. In some embodiments, the traffic data comprises vehicle density, vehicle velocity, and/or vehicle trajectory. In some embodiments, the traffic data is provided by the vehicle operations and control system and/or other shared mobility systems. In some embodiments, traffic incidents comprise extreme conditions, major and/or minor accident, and/or a natural disaster. In some embodiments, an interface allows the vehicle operations and control system to assume control of vehicles upon occurrence of a traffic event, extreme weather, or pavement breakdown when alerted by the vehicle operations and control system and/or other shared mobility systems. In some embodiments, an interface allows vehicles to form a platoon with other vehicles when they are driving in the same automated vehicle dedicated lane.

In some embodiments, the VIU comprises a communication module configured to communicate with an RIU. In some embodiments, the VIU comprises a communication module configured to communicate with another VIU. In some embodiments, the VIU comprises a data collection module configured to collect data from external vehicle sensors and internal vehicle sensors; and to monitor vehicle status and driver status. In some embodiments, the VIU comprises a vehicle control module configured to execute control instructions for driving tasks. In some embodiments, the driving tasks comprise car following and/or lane changing. In some embodiments, the control instructions are received from an RIU. In some embodiments, the VIU is configured to control a vehicle using data received from an RIU. In some embodiments, the data received from the RIU comprises vehicle control instructions (e.g., detailed and time-sensitive control instructions for individual vehicles); travel route and traffic information; and/or services information. In some embodiments, the vehicle control instructions comprise a longitudinal acceleration rate, a lateral acceleration rate, and/or a vehicle orientation. In some embodiments, the travel route and traffic information comprise traffic conditions, incident location, intersection location, entrance location, and/or exit location. In some embodiments, the services data comprises the location of a fuel station and/or location of a point of interest. In some embodiments, a VIU is configured to send data to an RIU. In some embodiments, the data sent to the RIU comprises driver input data; driver condition data; and/or vehicle condition data. In some embodiments, the driver input data comprises origin of the trip, destination of the trip, expected travel time, and/or service requests. In some embodiments, the driver condition data comprises driver behaviors, fatigue level, and/or driver distractions. In some embodiments, the vehicle condition data comprises vehicle ID, vehicle type, and/or data collected by a data collection module.

In some embodiments, the VIU is configured to collect data comprising vehicle engine status; vehicle speed; surrounding objects detected by vehicles; and/or driver conditions. In some embodiments, the VIU is configured to assume control of a vehicle. In some embodiments, the VIU is configured to assume control of a vehicle when the automated driving system fails. In some embodiments, the VIU is configured to assume control of a vehicle when the vehicle condition and/or traffic condition prevents the automated driving system from driving the vehicle. In some embodiments, the vehicle condition and/or traffic condition is adverse weather conditions, a traffic incident, a system failure, and/or a communication failure.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

We claim:

1. A collaborative automated driving system (CADS) comprising:
a cooperative management (CM) subsystem;
a road subsystem;
a vehicle subsystem;
a user subsystem;
a communications subsystem; and/or
a supporting subsystem, optionally comprising a cloud subsystem and/or a map subsystem.

2. The CADS of claim 1 configured to provide transportation management.

3. The CADS of claim 1 configured to provide full vehicle operations and control for connected and automated vehicle and highway systems by sending individual vehicles with detailed and time-sensitive control instructions for vehicle operations.

4. The CADS of claim 1 wherein the CM subsystem is configured to process information, coordinate and allocate resources, and/or send traffic operations instructions to the road subsystem; the vehicle subsystem; the user subsystem; the communications subsystem; and/or a supporting subsystem.

5. The CADS of claim 1 wherein the CM subsystem is configured to perform a binding method.

6. The CADS of claim 1 wherein the road subsystem comprises RIU.

7. The CADS of claim 6 wherein the RIU are configured to receive data and/or information from connected vehicles, detect traffic conditions, and/or send targeted control instructions to vehicles.

8. The CADS of claim 1 wherein the vehicle subsystem is configured to provide automated driving to a vehicle.

9. The CADS of claim 1 wherein the vehicle subsystem is configured to provide automated driving to a plurality of vehicles and the plurality of vehicles comprises vehicles having different intelligence levels, vehicles having different brands and/or manufacturers, vehicles having different model years, and/or different vehicle models.

10. The CADS of claim 1 wherein the vehicle subsystem is configured to coordinate with the CM subsystem; the road subsystem; the user subsystem; the communications subsystem; and/or a supporting subsystem to provide automated driving for vehicles.

11. The CADS of claim 1 wherein the user subsystem comprises vehicle users.

12. The CADS of claim 1 wherein the user subsystem comprises transportation administrators.

13. The CADS of claim 11 wherein the vehicle users are drivers and/or passengers.

14. The CADS of claim 1 wherein the user subsystem exchanges information with the cooperative management subsystem; the road subsystem; the vehicle subsystem; the communication subsystem; and/or the supporting subsystem.

15. The CADS of claim 1 wherein the communication subsystem is configured to provide wired and/or wireless communication services to the CADS and/or CADS subsystems.

16. The CADS of claim 1 wherein the supporting subsystem is configured to provide physical and/or technical support to the CADS.

17. The CADS of claim 1 wherein the supporting subsystem is configured to provide physical and/or technical support for the transportation services provided to users.

18. The CADS of claim 1 wherein the supporting subsystem is configured to provide physical and/or technical support to transportation operations and collaborative automated driving.

19. The CADS of claim 1 wherein the supporting subsystem comprises:
a cloud subsystem;
an edge computing subsystem;
a map subsystem;
a high-precision positioning system; and/or
a cybersecurity system.

20. The CADS of claim 1 configured to complement, enhance, backup, elevate, and/or replace automated driving functions of a vehicle.

21. The CADS of claim 1 comprising a module configured to complement, enhance, backup, elevate, and/or replace automated driving functions of a vehicle.

22. The CADS of claim 20 wherein the automated driving functions of a vehicle comprise sensing, decision making, and/or control.

23. The CADS of claim 20 wherein the automated driving functions of a vehicle comprise sensing, prediction, planning, and/or control.

24. The CADS of claim 1 configured to complement, enhance, backup, elevate, and/or replace automated driving functions of a vehicle driving in a long-tail environment and/or scenario.

25. The CADS of claim 1 wherein the CM subsystem comprises a TCC and/or a TCU.

26. The CADS of claim 1 wherein the CM subsystem comprises a regional TCC; a corridor TCC; a segment TCU; and/or a point TCU.

27. The CADS of claim 1 wherein the CM subsystem is configured to be operated independently by a service provider.

28. The CADS of claim 1 wherein the CM subsystem is configured to perform a binding method comprising identifying the vehicle subsystem, the road subsystem, or the cloud subsystem as a dominant subsystem.

29. The CADS of claim 28, wherein identifying the vehicle subsystem, road subsystem, or cloud subsystem as a dominant subsystem comprises checking the Operation Design Domain (ODD) of a site or corridor requesting CADS services.

30. The CADS of claim 1 wherein the CM is configured to perform a Vehicle-Dominant CM (VDCM) method, a Road-Dominant CM (RDCM) method, and/or a Cloud-Dominant CM (CDCM) method.

31. The CADS of claim 28 wherein the CM is configured to perform a Cloud-Dominant CM (VDCM) method when the cloud subsystem is identified as the dominant subsystem.

32. The CADS of claim 31 wherein the cloud subsystem is configured to control the CM subsystem and the CM subsystem is configured to control and/or manage the road subsystem; the vehicle subsystem; the communication subsystem; the user subsystem; and/or the supporting subsystems.

33. The CADS of claim 28 wherein the CM is configured to perform a Vehicle-Dominant CM (VDCM) method when the vehicle subsystem is identified as the dominant subsystem.

34. The CADS of claim 33 wherein the vehicle subsystem is configured to control the CM subsystem and the CM subsystem is configured to control and/or manage the road subsystem; the communication subsystem; the user subsystem; and/or the supporting subsystems.

35. The CADS of claim 33 wherein the vehicle subsystem is configured to complement, enhance, backup, elevate, and/or replace vehicle centric automated driving functions.

36. The CADS of claim 28 wherein the CM is configured to perform a Road-Dominant CM method when the road subsystem is identified as the dominant subsystem.

37. The CADS of claim 36 wherein the road subsystem is configured to control the CM subsystem and the CM subsystem is configured to control and/or manage the vehicle subsystem; the communication subsystem; the user subsystem; and/or the supporting subsystems.

38. The CADS of claim 1 wherein the cloud subsystem comprises and/or provides a macroscopic cloud, a mesoscopic cloud, and/or microscopic cloud.

39. The CADS of claim 1 wherein the vehicle subsystem is configured to receive information from the cooperative management subsystem; the road subsystem; the communication subsystem; the user subsystem; and/or the supporting subsystems.

40. The CADS of claim 1, wherein the vehicle subsystem comprises a vehicle adapter and/or a vehicle intelligent unit (VIU).

41. The CADS of claim 40 wherein the VIU is configured to manage automated driving functions.

42. The CADS of claim 40 wherein the vehicle adapter provides an interface configured to exchange information between a vehicle and CADS, between a vehicle and a CADS subsystem, between a vehicle and road infrastructure, between a vehicle and a user, and/or between a vehicle and a supporting subsystem.

43. The CADS of claim 40 wherein the VIU is configured to manage sensing, prediction, planning, and/or control functions for a vehicle.

44. The CADS of claim 40 wherein the VIU is configured to manage sensing, prediction, planning, and/or control functions for a plurality of vehicles and the plurality of vehicles comprises vehicles having different intelligence levels, vehicles having different brands and/or manufacturers, vehicles having different model years, and/or different vehicle models.

45. The CADS of claim 1 wherein the road subsystem is configured to receive information from the cooperative management subsystem; the vehicle subsystem; the communication subsystem; the user subsystem; and/or the supporting subsystems.

46. The CADS of claim 1 wherein the road subsystem is configured to complete and/or support automated driving functions.

47. The CADS of claim 1 wherein the road subsystem is configured to manage sensing, prediction, planning, and/or control functions for a vehicle.

48. The CADS of claim 1 wherein the road subsystem is configured to manage sensing, prediction, planning, and/or control functions for a plurality of vehicles and the plurality of vehicles comprises vehicles having different intelligence levels, vehicles having different brands and/or manufacturers, vehicles having different model years, and/or different vehicle models.

49. The CADS of claim 1 wherein the user subsystem comprises a vehicle user and/or an administrator.

50. The CADS of claim 1 wherein the user subsystem is configured for use by a vehicle user and/or an administrator.

51. The CADS of claim 1 wherein a vehicle user is a driver and/or a passenger.

52. The CADS of claim 1 wherein the vehicle subsystem receives information from the cooperative management subsystem; the road subsystem; the vehicle subsystem; the communication subsystem; and/or the supporting subsystem and provides the information to a vehicle user and/or to an administrator.

53. The CADS of claim 52 wherein the information provided to a vehicle user is provided for a notification, a service, and/or emergency control of a vehicle.

54. The CADS of claim 52 wherein the information provided to an administrator is provided to control a vehicle and/or to manage traffic.

55. The CADS of claim 52 wherein the information provided to an administrator is provided to control and/or to manage the CADS.

56. The CADS of claim 1 wherein the map subsystem is configured to provide map information to the vehicle subsystem and/or to the road subsystem.

57. The CADS of claim 1 wherein the map subsystem comprises high-precision maps.

58. The CADS of claim 57 wherein the high-precision maps are provided at different resolutions.

59. The CADS of claim 1 wherein the map subsystem provides methods for high-precision positioning or location identification.

60. The CADS of claim 1 wherein the map subsystem is configured to integrate information from the cooperative management subsystem; the road subsystem; the vehicle subsystem; the communication subsystem; the user subsystem; and/or other supporting subsystems.

61. The CADS of claim 1 wherein the map subsystem is configured to support automated driving functions.

62. The CADS of claim 1 wherein the map subsystem is configured to provide navigation functions, positioning or location identification functions, and/or dynamic sensing and route planning functions.

63. The CADS system of claim 1 wherein the communication subsystem is configured to support information exchange among the cooperative management subsystem; the road subsystem; the vehicle subsystem; the communication subsystem; the user subsystem; and/or the supporting subsystems.

64. The CADS of claim 1 configured to support automated driving functions of a vehicle driving in a long-tail environment and/or scenario.

65. The CADS of claim 64 wherein the long-tail environment and/or scenario comprises an incident; an event; a construction and/or work zone; extreme and/or adverse weather; a hazardous road; an unclear road marking, sign, and/or geometric design; and/or a high concentration of pedestrians and/or bicycles.

66. A method comprising providing a CADS of any one of claims 1-65 to provide vehicle control and/or traffic management.
